(19) United States
(12) Patent Application Publication
(10) Pub. No.: US 2023/0006203 A1
(43) Pub. Date: Jan. 5, 2023

(54) POSITIVE ELECTRODE ACTIVE MATERIAL, SECONDARY BATTERY, AND VEHICLE

(71) Applicant: SEMICONDUCTOR ENERGY LABORATORY CO., LTD., ATSUGI-SHI, KANAGAWA-KEN (JP)

(72) Inventors: Yuji IWAKI, Isehara, Kanagawa (JP); Tatsuyoshi TAKAHASHI, Atsugi, Kanagawa (JP); Yohei MOMMA, Isehara, Kanagawa (JP); Shunpei YAMAZAKI, Setagaya, Tokyo (JP)

(21) Appl. No.: 17/781,178

(22) PCT Filed: Nov. 25, 2020
(86) PCT No.: PCT/IB2020/061112

§ 371 Date: May 31, 2022

(30) Foreign Application Priority Data
Dec. 4, 2019 (JP) 2019-219306
Jan. 23, 2020 (JP) 2020-009008

(51) Int. Cl. H01M 4/525; C01G 51/00; B60L 50/64

(52) U.S. Cl. CPC H01M 4/525; C01G 51/42; B60L 50/64; H01M 2004/028

(57) ABSTRACT

As for a secondary battery using lithium cobalt oxide as a positive electrode active material, the positive electrode active material with which a decrease in battery capacity due to repeated charge and discharge is inhibited is provided. Alternatively, a positive electrode active material particle which hardly deteriorates is provided. The positive electrode active material includes lithium, cobalt, oxygen, magnesium, aluminum, and fluorine and is a crystal represented by a layered rock-salt structure. The space group of the crystal is represented by R−3m. The concentration of fluorine in a surface portion of the crystal is higher than that inside the crystal. The concentration of magnesium in the surface portion of the crystal is higher than that inside the crystal. The atomic ratio of magnesium to aluminum in the surface portion of the crystal is higher than that inside the crystal.

### TECHNICAL FIELD

One embodiment of the present invention relates to a secondary battery including a positive electrode active material and a manufacturing method thereof.

One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification generally mean devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

Thus, improvement of a positive electrode active material has been studied to increase the cycle performance and the capacity of the lithium-ion secondary battery (Patent Document 1).

The performances required for power storage devices are safe operation and longer-term reliability under various environments, for example.

### REFERENCE

### Patent Document

[Patent Document 1] Japanese Published Patent Application No. 2019-21456

### SUMMARY OF THE INVENTION

### Problems to be Solved by the Invention

Lithium-ion secondary batteries and positive electrode active materials used therein need various improvements in capacity, cycle characteristics, charge and discharge characteristics, reliability, safety, cost, and the like.

A material with a layered rock-salt crystal structure, such as lithium cobalt oxide (LiCoO₂), is known to have a high discharge capacity and excel as a positive electrode active material of a secondary battery.

Secondary batteries including lithium cobalt oxide as positive electrode active materials have a problem of a decrease in the battery capacity due to repeated charge and discharge or the like.

In view of the above, an object of one embodiment of the present invention is to provide a positive electrode active material particle with little deterioration. Another object of one embodiment of the present invention is to provide a novel positive electrode active material particle. Another object of one embodiment of the present invention is to provide a power storage device with little deterioration. Another object of one embodiment of the present invention is to provide a highly safe power storage device. Another object of one embodiment of the present invention is to provide a novel power storage device.

Note that the description of these objects does not preclude the existence of other objects. One embodiment of the present invention does not have to achieve all these objects. Other objects can be derived from the description of the specification, the drawings, and the claims.

### Means for Solving the Problems

One embodiment of the present invention is a positive electrode active material that includes lithium, cobalt, oxygen, magnesium, aluminum, and fluorine, and is a crystal represented by a layered rock-salt structure, in which the space group of the crystal is represented by R-3m; the concentration of the fluorine is higher in a surface portion of the crystal than inside the crystal; the concentration of the magnesium is higher in the surface portion of the crystal than inside the crystal; and the atomic ratio of the magnesium to the aluminum is higher in the surface portion of the crystal than inside the crystal.

Another embodiment of the present invention is a positive electrode active material that includes lithium, cobalt, oxygen, magnesium, aluminum, and fluorine, and is a crystal represented by a layered rock-salt structure, in which the space group of the crystal is represented by R-3m; the concentration of the fluorine is higher in a surface portion of the crystal than inside the crystal; the concentration of the magnesium is higher in the surface portion of the crystal than inside the crystal; the atomic ratio of the magnesium to the aluminum is higher in the surface portion of the crystal than inside the crystal; a region in contact with an outside of a surface of the crystal is included; the region includes magnesium, lithium, and fluorine; and the concentration of the fluorine with respect to the concentration of the magnesium is higher in the region than in the surface portion of the crystal.

In the above structure, it is preferable that titanium be further included, and the atomic ratio of the magnesium to the titanium be higher in the surface portion of the crystal than inside the crystal.

In the above structure, it is preferable that nickel and titanium be further included, the atomic ratio of the magnesium to the nickel be higher in the surface portion of the crystal than inside the crystal, and the atomic ratio of the magnesium to the titanium be higher in the surface portion of the crystal than inside the crystal.

Another embodiment of the present invention is a positive electrode active material that includes lithium, cobalt, oxygen, magnesium, aluminum, and fluorine, and is a crystal represented by a layered rock-salt structure, in which the space group of the crystal is represented by R-3m; the crystal includes a first region and a second region; the first region is in contact with a surface of the crystal; the second region is positioned inward from the first region; the concentration of the fluorine is higher in the first region than in the second region; the concentration of the magnesium is higher in the first region than in the second region; and the atomic ratio of the magnesium to the aluminum is higher in the first region than in the second region.

Another embodiment of the present invention is a positive electrode active material that includes lithium, cobalt, oxygen, magnesium, aluminum, and fluorine, and is a crystal represented by a layered rock-salt structure, in which the space group of the crystal is represented by R-3m; the crystal includes a first region and a second region; the first region is in contact with a surface of the crystal; the second region is positioned inward from the first region; the concentration of the fluorine is higher in the first region than in the second region; the concentration of the magnesium is higher in the first region than in the second region; the atomic ratio of the magnesium to the aluminum is higher in the first region than in the second region; the crystal includes a third region; the third region is in contact with the surface of the crystal; the third region includes magnesium, lithium, and fluorine; and the concentration of the fluorine with respect to the concentration of the magnesium is higher in the third region than in the first region.

In the above structure, it is preferable that titanium be further included, and the atomic ratio of the magnesium to the titanium be higher in the first region than in the second region.

In the above structure, it is preferable that titanium and nickel be further included, the atomic ratio of the magnesium to the titanium be higher in the first region than in the second region, and the atomic ratio of the magnesium to the nickel be higher in the first region than in the second region.

In the above structure, it is preferable that the first region be a region from the surface of the crystal to a depth of less than or equal to 50 nm.

In the above structure, it is preferable that the first region be a region from the surface of the crystal to a depth of less than or equal to 50 nm, further preferably less than or equal to 35 nm, still further preferably less than or equal to 20 nm. In this specification and the like, the surface sometimes refers to a region from an uppermost surface to a depth of less than or equal to 50 nm, preferably less than or equal to 35 nm, further preferably less than or equal to 20 nm, for example.

Another embodiment of the present invention is a secondary battery including a positive electrode including the above-described positive electrode active material, a negative electrode, and an electrolyte.

Another embodiment of the present invention is a vehicle including the above-described secondary battery, an electric motor, and a control device, in which the control device has a function of supplying power from the secondary battery to the electric motor.

### Effect of the Invention

According to one embodiment of the present invention, a positive electrode active material particle with little deterioration can be provided. According to another embodiment of the present invention, a method for manufacturing a positive electrode active material can be provided. According to another embodiment of the present invention, a novel positive electrode active material particle can be provided. According to another embodiment of the present invention, a novel power storage device can be provided.

### BRIEF DESCRIPTION OF THE DRAWINGS

FIG. 1 is a diagram illustrating crystal structures of a positive electrode active material.

FIG. 2 is a diagram illustrating crystal structures of a positive electrode active material.

FIG. 3A and FIG. 3B are diagrams relating to quantum molecular dynamics calculation.

FIG. 4A and FIG. 4B are diagrams relating to quantum molecular dynamics calculation.

FIG. 5A and FIG. 5B are diagrams relating to quantum molecular dynamics calculation.

FIG. 6A and FIG. 6B are diagrams relating to quantum molecular dynamics calculation.

FIG. 7A, FIG. 7B, and FIG. 7C are diagrams relating to quantum molecular dynamics calculation.

FIG. 8A and FIG. 8B are diagrams relating to quantum molecular dynamics calculation.

FIG. 9A and FIG. 9B are diagrams relating to quantum molecular dynamics calculation.

FIG. 10A and FIG. 10B are diagrams relating to quantum molecular dynamics calculation.

FIG. 11A and FIG. 11B are diagrams relating to first principles calculation.

FIG. 12A is a diagram relating to quantum molecular dynamics calculation.

FIG. 13A and FIG. 13B are diagrams relating to quantum molecular dynamics calculation.

FIG. 14A, FIG. 14B, and FIG. 14C are diagrams relating to quantum molecular dynamics calculation.

FIG. 15A, FIG. 15B, and FIG. 15C are diagrams relating to quantum molecular dynamics calculation.

FIG. 16A, FIG. 16B, and FIG. 16C are diagrams relating to quantum molecular dynamics calculation.

FIG. 17A, FIG. 17B, and FIG. 17C are diagrams relating to quantum molecular dynamics calculation.

FIG. 18 is an example of a flowchart illustrating one embodiment of the present invention.

FIG. 19 is an example of a process cross-sectional view illustrating one embodiment of the present invention.

FIG. 20 is a STEM image of an active material particle, showing one embodiment of the present invention.

FIG. 21A is a STEM image showing a comparative example, and FIG. 21B is an enlarged image of a part thereof.

FIG. 22A illustrates conditions of this embodiment, and FIG. 22B illustrates a comparative example.

FIG. 23 shows cycle performance of secondary batteries.

FIG. 24A is a perspective view of the secondary battery, FIG. 24B is a cross-sectional perspective view of the secondary battery, and FIG. 24C is a schematic cross-sectional view at the time of charge.

FIG. 25A is a perspective view of a secondary battery, FIG. 25B is a cross-sectional perspective view of the secondary battery, FIG. 25C is a perspective view of a battery pack including a plurality of secondary batteries, and FIG. 25D is a top view of the battery pack.

FIG. 26A and FIG. 26B are diagrams illustrating an example of a secondary battery.

FIG. 27A and FIG. 27B are diagrams illustrating a laminated secondary battery.

FIG. 28A and FIG. 28B are diagrams illustrating an example of a secondary battery.

FIG. 29A, FIG. 29B, FIG. 29C, FIG. 29D, and FIG. 29E are perspective views of electronic devices.

FIG. 30A, FIG. 30B, and FIG. 30C are diagrams relating to quantum molecular dynamics calculation.

FIG. 31A, FIG. 31B, and FIG. 31C are diagrams relating to quantum molecular dynamics calculation.

FIG. 32A and FIG. 32B are diagrams relating to quantum molecular dynamics calculation.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

For example, in the case where one particle is formed of one crystal grain, a surface of the particle is referred to as a surface of a crystal in some cases. Furthermore, for example, in the case where a plurality of crystals are adjacent to each other, a crystal grain boundary corresponds to a surface of the crystal in some cases.

### EMBODIMENT 1

In this embodiment, an example of a structure of a positive electrode active material manufactured by a manufacturing method of one embodiment of the present invention is described.

A positive electrode active material of one embodiment of the present invention includes fluorine. Fluorine can improve the wettability of a surface of the positive electrode active material, so that the surface can be homogenized. The crystal structure of the positive electrode active material obtained in this manner is less likely to be broken with repeated high-voltage charge and discharge, and a secondary battery including the positive electrode active material having such a feature has greatly improved cycle characteristics.

When the unevenness of the surface of an active material particle of the positive electrode active material of one embodiment of the present invention falls within a certain range, the strength of the vicinity of the surface or a surface portion is increased to provide a positive electrode active material particle with less deterioration. For example, a lithium oxide and a fluoride are mixed and heated to form a positive electrode active material particle.

When a portion where pure LiCoO₂ is exposed exists on the surface of the positive electrode active material particle, projections and depressions are generated and cobalt or oxygen is deintercalated at the time of charge and discharge to break the crystal structure, thereby causing deterioration. In order not to expose the pure LiCoO₂ on the surface, it is preferable to uniformly cover the surface with a compound including magnesium. Magnesium has a function of maintaining the crystal structure (layered rock-salt crystal structure) when Li is deintercalated at the time of discharge. The magnesium (or fluorine) existing in the vicinity of the surface of the positive electrode active material particle or in the surface portion is also one of the features.

With the above structure, even when pressure is applied to a positive electrode including the positive electrode active material in manufacturing a secondary battery, a crack is less likely to be generated and the shape of the particle can be maintained. This can cause less excess cracks to increase the electrode density.

In the case where surface unevenness is larger than the above range and the surface is rough, a crack and breakage of the crystal structure might be caused physically. With the breakage of the crystal structure, pure LiCoO₂ might be exposed on the surface to accelerate deterioration.

As the lithium oxide, a material with a layered rock-salt crystal structure is preferable; a composite oxide represented by LiMO₂ is given, for example. As an example of the element M, one or more elements selected from Co and Ni can be given. As another example of the element M, in addition to one or more elements selected from Co and Ni, one or more elements selected from Al and Mg can be given.

When fluorine is included in the vicinity of the surface or in the surface portion, not only fluorine but also magnesium, aluminum, and nickel can be put in the vicinity of the surface or in the surface portion at high concentrations. The fluorine is inhibited from diffusing outward as a gas during annealing with the container covered with a lid, and the other elements such as aluminum diffuse into the solid material. The fluorine improves the wettability of the surface of the positive electrode active material, so that the surface is homogenized.

The composite oxide containing lithium, the transition metal, and oxygen preferably has a layered rock-salt crystal structure with few defects and distortions. Therefore, the composite oxide is preferably a composite oxide with few impurities. In the case where the composite oxide containing lithium, the transition metal, and oxygen includes a large amount of impurities, the crystal structure is highly likely to have a large number of defects or distortions.

In order that no impurity is included, it is preferable to perform heating with the lid put on after the fluoride is mixed to conduct surface modification of the positive electrode active material. The timing of putting the lid on the container is any one of the following: the lid is put so as to cover the container before heating, and then the container is placed in a heating furnace; the container is placed on the furnace, and then the lid is put so as to cover the container; the lid is put on the container during heating before the fluoride is melted.

### [Structure of Positive Electrode Active Material]

A material with a layered rock-salt crystal structure, such as lithium cobalt oxide (LiCoO₂), is known to have a high discharge capacity and excel as a positive electrode active material of a secondary battery. As an example of the material with a layered rock-salt crystal structure, a composite oxide represented by LiMO₂ is given. As an example of the element M, one or more selected from Co and Ni can be given. As another example of the element M, in addition to one or more elements selected from Co and Ni, one or more elements selected from Al and Mg can be given.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when high-voltage charge and discharge are performed on LiNiO₂, the crystal structure might be broken because of the distortion. The influence of the Jahn-Teller effect is suggested to be small in LiCoO₂; hence, LiCoO₂ is preferable because the resistance to high-voltage charge and discharge is higher in some cases.

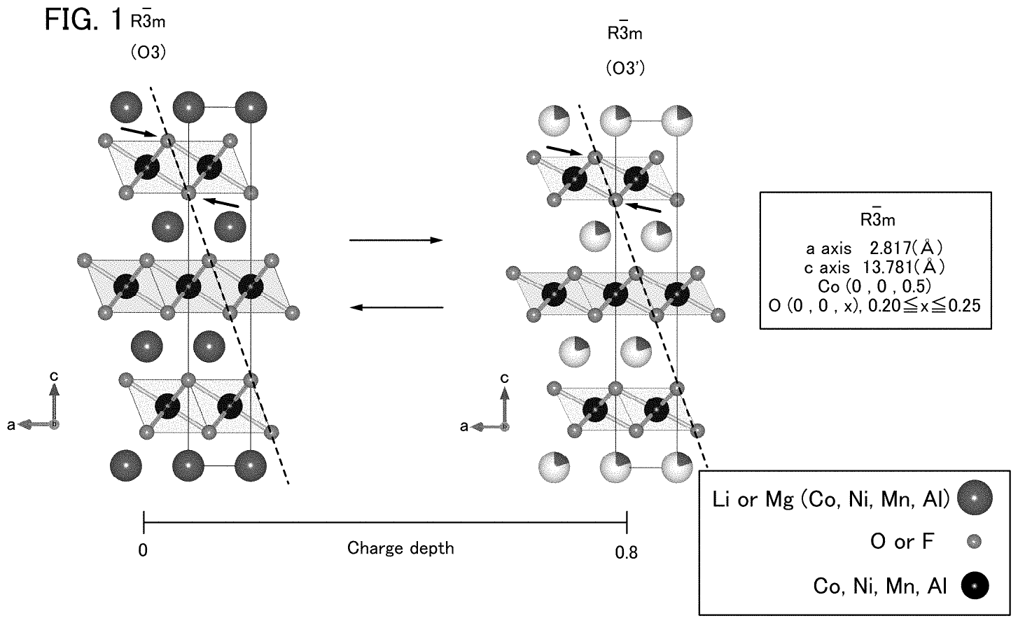

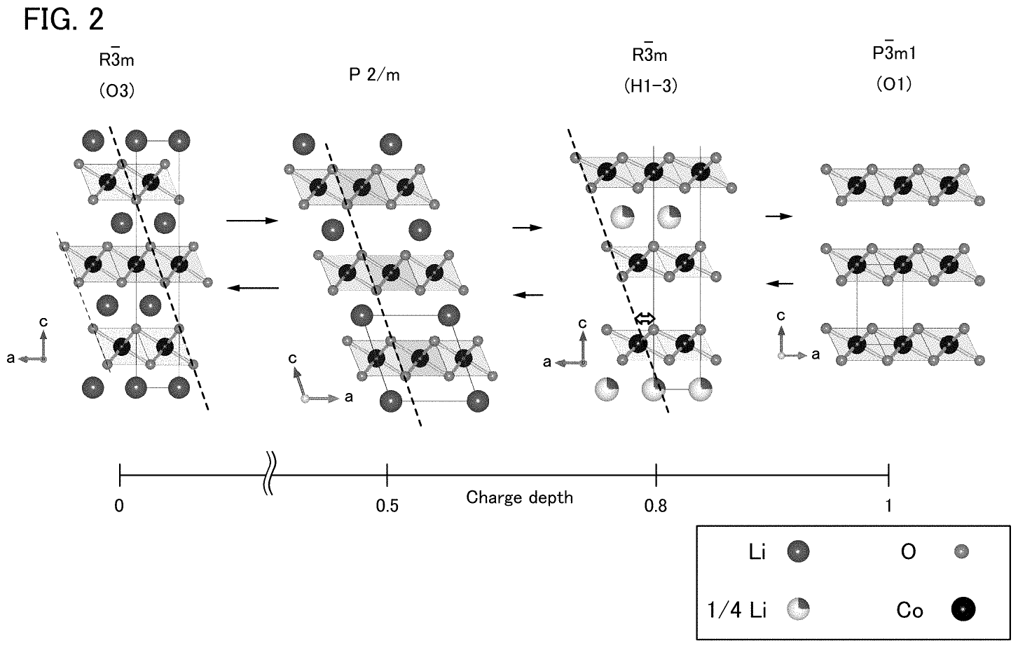

The positive electrode active material is described with reference to FIG. 1 and FIG. 2. In FIG. 1 and FIG. 2, the case where cobalt is used as a transition metal contained in the positive electrode active material is described.

In the positive electrode active material formed by one embodiment of the present invention, the difference in the positions of CoO₂ layers can be small in repeated charge and discharge at high voltage. Furthermore, the change in the volume can be small. Accordingly, the positive electrode active material of one embodiment of the present invention can achieve excellent cycle performance. In addition, the positive electrode active material of one embodiment of the present invention can have a stable crystal structure in a high-voltage charging state. Thus, in the positive electrode active material of one embodiment of the present invention, a short circuit is less likely to occur while the high-voltage charging state is maintained. This is preferable because the safety is further improved.

The positive electrode active material of one embodiment of the present invention has a small change in the crystal structure and a small difference in volume per the same number of transition metal atoms between a sufficiently discharging state and a high-voltage charging state.

FIG. 1 illustrates the crystal structures of a positive electrode active material 904 before and after being charged and discharged. The positive electrode active material 904 is a composite oxide including lithium, cobalt, and oxygen. In addition to the above, the positive electrode active material 904 preferably includes magnesium. Furthermore, the positive electrode active material 904 preferably includes halogen such as fluorine or chlorine. The positive electrode active material 904 preferably contains aluminum and nickel.

The crystal structure with a charge depth of 0 (in the discharged state) in FIG. 1 is R-3m (O3) as in FIG. 2. Meanwhile, the positive electrode active material 904 with a charge depth in a sufficiently charged state includes a crystal whose structure is different from the H1-3 type structure (the space group R-3m) illustrated in FIG. 2. This structure belongs to the space group R-3m, and is not a spinel crystal structure but a structure in which oxygen is hexacoordinated to ions of cobalt, magnesium, or the like and the cation arrangement has symmetry similar to that of the spinel crystal structure. Furthermore, the symmetry of CoO₂ layers of this structure is the same as that in the O3 type structure. Accordingly, this structure is referred to as an O3′ type crystal structure or a pseudo-spinel crystal structure in this specification and the like. Note that although lithium exists in any of lithium sites at an approximately 20% probability in the diagram of the O3′ type crystal structure illustrated in FIG. 1, the structure is not limited thereto. Lithium may exist in only some certain lithium sites. In addition, in both the O3 type crystal structure and the O3′ type crystal structure, a slight amount of magnesium preferably exists between the CoO₂ layers, i.e., in lithium sites. In addition, a slight amount of halogen such as fluorine preferably exists in oxygen sites at random.

Note that in the O3′ type crystal structure, oxygen is tetracoordinated to a light element such as lithium in some cases; also in that case, the ion arrangement has symmetry similar to that of the spinel structure.

The O3′ type crystal structure can also be regarded as a crystal structure that includes Li between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

Anions of a layered rock-salt crystal and anions of a rock-salt crystal have a cubic close-packed structure (face-centered cubic lattice structure). Anions of an O3′ type crystal are also presumed to have a cubic close-packed structure. When the O3′ type crystal is in contact with the layered rock-salt crystal and the rock-salt crystal, there is a crystal plane at which orientations of cubic close-packed structures composed of anions are aligned. Note that a space group of the layered rock-salt crystal and the O3′ type crystal is R-3m, which is different from a space group Fm−3m of a rock-salt crystal (a space group of a general rock-salt crystal) and a space group Fd−3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned is sometimes referred to as a state where crystal orientations are substantially aligned.

In the positive electrode active material 904, a change in the crystal structure when the positive electrode active material 904 is charged with high voltage and a large amount of lithium is extracted is inhibited as compared with a comparative example described later. As shown by dotted lines in FIG. 1, for example, CoO₂ layers hardly deviate in the crystal structures.

More specifically, the structure of the positive electrode active material 904 is highly stable even when a charge voltage is high. For example, an H1-3 type structure is formed at a voltage of approximately 4.6 V with the potential of a lithium metal as the reference in FIG. 2; however, the positive electrode active material 904 can maintain the crystal structure of R-3m (O3) even at the voltage of approximately 4.6 V. Even at higher charge voltages, e.g., a voltage of approximately 4.65 V to 4.7 V with the potential of a lithium metal as the reference, the positive electrode active material of one embodiment of the present invention can have the O3′ type crystal structure. At a charge voltage increased to be higher than 4.7 V, an H1-3 type crystal may be finally observed in the positive electrode active material of one embodiment of the present invention. In addition, the positive electrode active material of one embodiment of the present invention might have the O3′ type structure even at a lower charge voltage (e.g., a charge voltage of greater than or equal to 4.5 V and less than 4.6 V with the potential of a lithium metal as the reference).

Note that in the case where graphite is used as a negative electrode active material in a secondary battery, for example, the voltage of the secondary battery is lower than the above-mentioned voltages by the potential of graphite. The potential of graphite is approximately 0.05 V to 0.2 V with the potential of a lithium metal as the reference. Thus, even in a secondary battery that includes graphite as a negative electrode active material and has a voltage of greater than or equal to 4.3 V and less than or equal to 4.5 V, for example, the positive electrode active material of one embodiment of the present invention can maintain the crystal structure of R-3m (O3) and moreover, can have the O3′ type structure at higher voltages, e.g., a voltage of the secondary battery of greater than 4.5 V and less than or equal to 4.6 V. In addition, the positive electrode active material of one embodiment of the present invention can have the O3′ type structure at lower charge voltages, e.g., at a voltage of the secondary battery of greater than or equal to 4.2 V and less than 4.3 V, in some cases.

Thus, in the positive electrode active material 904, the crystal structure is less likely to be broken even when charge and discharge are repeated at high voltage.

In the positive electrode active material 904, a difference in the volume per unit cell between the 03 type crystal structure with a charge depth of 0 and the O3′ type crystal structure with a charge depth of 0.8 is less than or equal to 2.5%, more specifically, less than or equal to 2.2%.

In the unit cell of the O3′ type crystal structure, coordinates of cobalt and oxygen can be represented by Co (0, 0, 0.5) and O (0, 0, x) within the range of 0.20≤x≤0.25.

A slight amount of additive substances, such as magnesium, existing between the CoO₂ layers, i.e., in lithium sites at random, has an effect of inhibiting a deviation in the CoO₂ layers in high-voltage charging. Thus, when magnesium exists between the CoO₂ layers, the O3′ type crystal structure is likely to be formed.

However, cation mixing occurs when the heat treatment temperature is excessively high, so that magnesium is highly likely to enter the cobalt sites. Magnesium in the cobalt sites is less effective in maintaining the R-3m structure in high-voltage charging in some cases. Furthermore, when the heat treatment temperature is excessively high, adverse effects such as reduction of cobalt to have a valence of two and transpiration of lithium are concerned.

In view of the above, a halogen compound such as a fluorine compound is preferably added to lithium cobalt oxide before the heat treatment for distributing magnesium over whole particles. The addition of the halogen compound depresses the melting point of lithium cobalt oxide. The depression of the melting point makes it easier to distribute magnesium over whole particles at a temperature at which the cation mixing is unlikely to occur. Furthermore, it is expected that the existence of the fluorine compound can improve corrosion resistance to hydrofluoric acid generated by decomposition of an electrolyte solution.

When the magnesium concentration is higher than a predetermined value, the effect of stabilizing a crystal structure becomes small in some cases. This is probably because magnesium enters the cobalt sites in addition to the lithium sites. The number of magnesium atoms in the positive electrode active material formed by one embodiment of the present invention is preferably 0.001 times or more and 0.1 times or less, further preferably more than 0.01 times and less than 0.04 times, still further preferably approximately 0.02 times as large as the number of cobalt atoms. The magnesium concentration described here may be a value obtained by element analysis on the entire particles of the positive electrode active material using ICP-MS or the like, or may be a value based on the ratio of the raw materials mixed in the forming process of the positive electrode active material, for example.

The number of nickel atoms in the positive electrode active material 904 is preferably 7.5% or lower, preferably 0.05% or higher and 4% or lower, further preferably 0.1% or higher and 2% or lower of the number of cobalt atoms. The nickel concentration described here may be a value obtained by element analysis on the entire particle of the positive electrode active material using ICP-MS or the like, or may be a value based on the ratio of the raw materials mixed in the forming process of the positive electrode active material, for example.

### <<Particle Size>>

A too large particle size of the positive electrode active material 904 causes problems such as difficulty in lithium diffusion and too much surface roughness of an active material layer in coating to a current collector. By contrast, a too small particle size causes problems such as difficulty in carrying the active material layer in coating to the current collector and overreaction with an electrolyte solution. Therefore, an average particle diameter (D50, also referred to as median diameter) is preferably more than or equal to 1 μm and less than or equal to 100 μm, further preferably more than or equal to 2 μm and less than or equal to 40 μm, still further preferably more than or equal to 5 μm and less than or equal to 30 μm.

### <Analysis Method>

Whether or not a positive electrode active material has the O3′ type crystal structure when charged with high voltage can be determined by analyzing a high-voltage charged positive electrode using XRD, electron diffraction, neutron diffraction, electron spin resonance (ESR), nuclear magnetic resonance (NMR), or the like. The XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example.

As described so far, the positive electrode active material 904 has a feature of a small change in the crystal structure between the high-voltage charged state and the discharged state. A material where 50 wt % or more of the crystal structure largely changes between the high-voltage charged state and the discharged state is not preferable because the material cannot withstand the high-voltage charge and discharge. In addition, it should be noted that an objective crystal structure is not obtained in some cases only by addition of impurity elements. For example, although the positive electrode active material that is lithium cobaltate containing magnesium and fluorine is a commonality, the positive electrode active material has 60 wt % or more of the O3′ type crystal structure in some cases, and has 50 wt % or more of the H1-3 type crystal structure in other cases, when charged with a high voltage. Furthermore, at a predetermined voltage, the positive electrode active material has almost 100 wt % of the O3′ type crystal structure, and with an increase in the predetermined voltage, the H1-3 type crystal structure is generated in some cases. Thus, the crystal structure of the positive electrode active material 904 is preferably analyzed by XRD or the like. The combination of the analysis methods and measurement such as XRD enables more detail analysis.

Note that a positive electrode active material in the high-voltage charged state or the discharged state sometimes causes a change in the crystal structure when exposed to air. For example, the O3′ type crystal structure changes into the H1-3 type crystal structure in some cases. Thus, all samples are preferably handled in an inert atmosphere such as an atmosphere including argon.

### COMPARATIVE EXAMPLE

A positive electrode active material illustrated in FIG. 2 is lithium cobalt oxide (LiCoO₂) to which halogen or magnesium is not added in a manufacturing method described later. The crystal structure of the lithium cobalt oxide illustrated in FIG. 2 is changed depending on a charge depth.

As illustrated in FIG. 2, lithium cobalt oxide with a charge depth of 0 (discharged state) includes a region having a crystal structure of the space group R-3m, and includes three CoO₂ layers in a unit cell. Thus, this crystal structure is referred to as an O3 type crystal structure in some cases. Note that the CoO₂ layer has a structure in which octahedral geometry with oxygen hexacoordinated to cobalt continues on a plane in the edge-sharing state.

When the charge depth is 1, LiCoO₂ has the crystal structure of the space group P−3m1, and one CoO₂ layer exists in a unit cell. Thus, this crystal structure is referred to as an O1 type crystal structure in some cases.

Moreover, lithium cobalt oxide with a charge depth of approximately 0.8 has the crystal structure of the space group R-3m. This structure can also be regarded as a structure in which CoO₂ structures such as P-3m1 (O1) and LiCoO₂ structures such as R-3m (O3) are alternately stacked. Thus, this crystal structure is referred to as an H1-3 type crystal structure in some cases. Note that the number of cobalt atoms per unit cell in the actual H1-3 type crystal structure is twice as large as that of cobalt atoms per unit cell in other structures. However, in this specification including FIG. 2, the c-axis of the H1-3 type crystal structure is half that of the unit cell for easy comparison with the other structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell including one cobalt and two oxygen. Meanwhile, the O3′ type crystal structure of one embodiment of the present invention is preferably represented by a unit cell including one cobalt and one oxygen. This means that the symmetry of cobalt and oxygen differs between the O3′ type crystal structure and the H1-3 type structure, and the amount of change from the O3 structure is smaller in the O3′ type crystal structure than in the H1-3 type structure. A preferred unit cell for representing a crystal structure in a positive electrode active material is selected such that the value of GOF (good of fitness) is smaller in the Rietveld analysis of XRD, for example.

When charge with a high voltage of 4.6 V or higher based on the redox potential of a lithium metal or charge with a large charge depth of 0.8 or more and discharge are repeated, the crystal structure of lithium cobalt oxide changes (i.e., an unbalanced phase change occurs) repeatedly between the H1-3 type crystal structure and the R-3m (O3) structure in a discharged state.

However, there is a large deviation in the position of the CoO₂ layer between these two crystal structures. As indicated by dotted lines and an arrow in FIG. 2, the CoO₂ layer in the H1-3 type crystal structure greatly shifts from that in the R-3m (O3) structure. Such a dynamic structural change might adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are continuous, such as P-3m1 (O1), included in the H1-3 type crystal structure is highly likely to be unstable.

Thus, the repeated high-voltage charge and discharge break the crystal structure of lithium cobalt oxide. The break of the crystal structure degrades the cycle performance. This is probably because the break of the crystal structure reduces sites where lithium can stably exist and makes it difficult to insert and extract lithium.

Next, the behavior of elements such as magnesium, fluorine, nickel, aluminum, and titanium in the positive electrode active material of one embodiment of the present invention was examined by quantum molecular dynamics calculation and first principles calculation.

### <Quantum Molecular Dynamics 1>

The stability of the structure of LiCoO₂ from which lithium in lithium layers was removed was examined by quantum molecular dynamics calculation, in which a structure where an atom was newly placed in the lithium layer and a structure where another atom was substituted for a Co atom in a CoO₂ layer were each used as the initial state. As the atom placed in the lithium layer, Mg, Li, Al, Ti, Co, and Ni were considered. As the atom substituted for the Co atom in the CoO₂ layer, Mg, Li, Al, Ti, and Ni were considered.

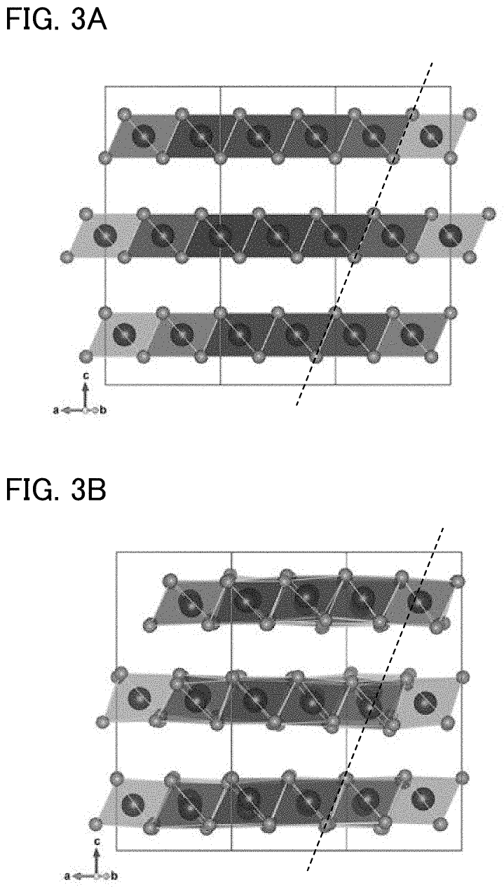

FIG. 3A shows the crystal structure of LiCoO₂ of the space group R-3m from which lithium in lithium layers is removed.

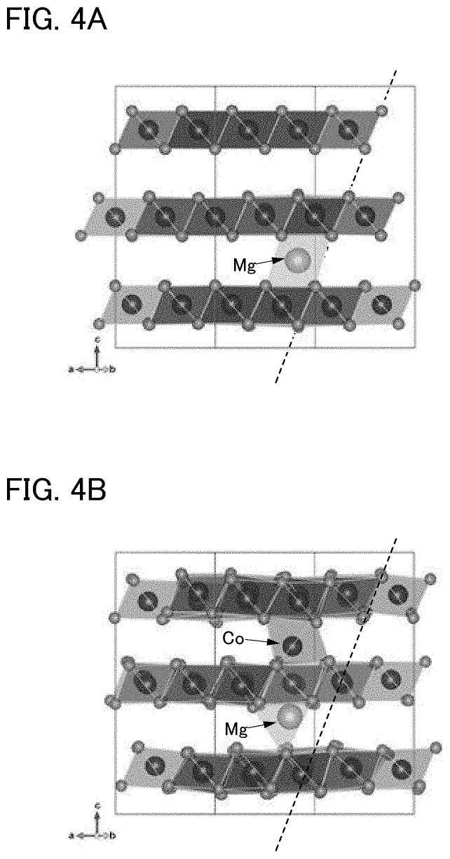

In the case where one atom was added to the lithium layer in the structure of FIG. 3A, a structure shown in FIG. 4A was used. FIG. 4A shows a structure to which a Mg atom is added, as an example. Also as for each of a Li atom, an Al atom, a Ti atom, a Co atom, and a Ni atom, a structure to which the atom was added in the same position was used.

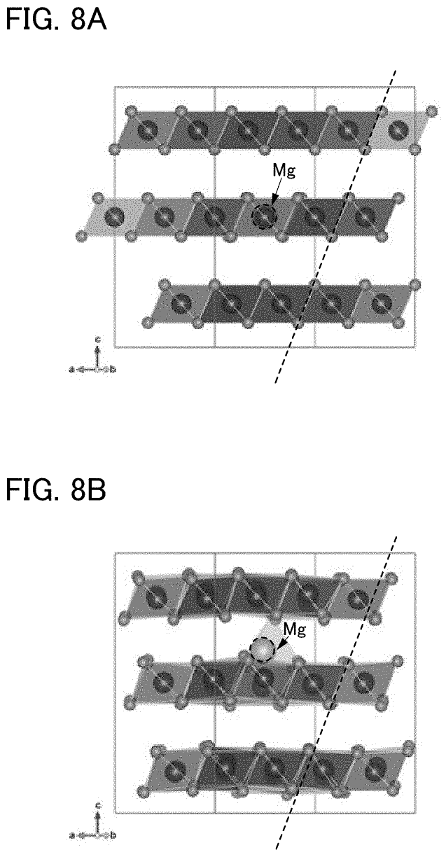

In the case where another atom is substituted for a Co atom in the CoO₂ layer in the structure of FIG. 3A, a structure shown in FIG. 8A was used. FIG. 8A shows a structure in which a Mg atom is substituted, as an example. Also as for each of a Li atom, an Al atom, a Ti atom, and a Ni atom, a structure in which the atom is substituted in the same position was used.

Table 1 shows specific calculation conditions of the quantum molecular dynamics calculation. A first principle electronic state calculation package, VASP (Vienna ab initio simulation package), was used for the atomic relaxation calculation. The total number of atoms was 144 when another atom is substituted for a Co atom in the CoO₂ layer and was 145 when one atom was added to the lithium layer. The calculation was performed under a temperature of 600 K.

TABLE 1

| Software | VASP |
|---|---|
| Functional | GGA + U (DFT-D2) |
| Pseudopotential | PAW |
| Cut-off energy (eV) | 600 |
| U potential | Co: 4.91 |
| k-points | 1 × 1 × 1 |

FIG. 3B shows calculation results after 8 ps at 600 K for the case where no atom is substituted in the lithium layer or the CoO₂ layer. It is found that misalignment of the CoO₂ layer occurs and the crystal structure is broken.

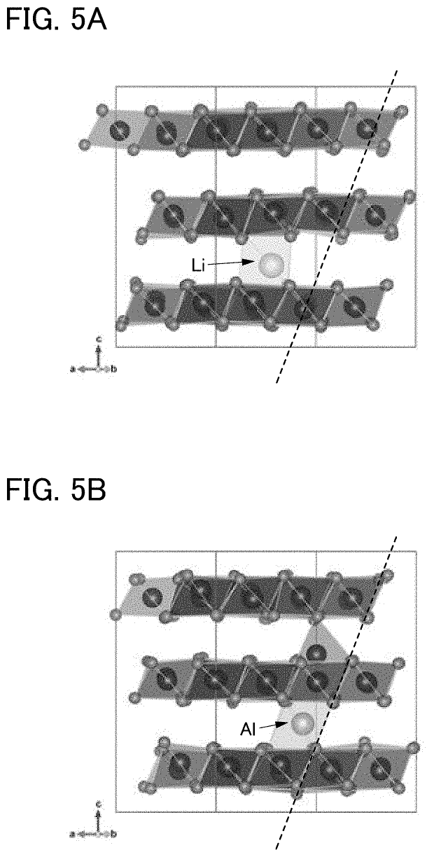

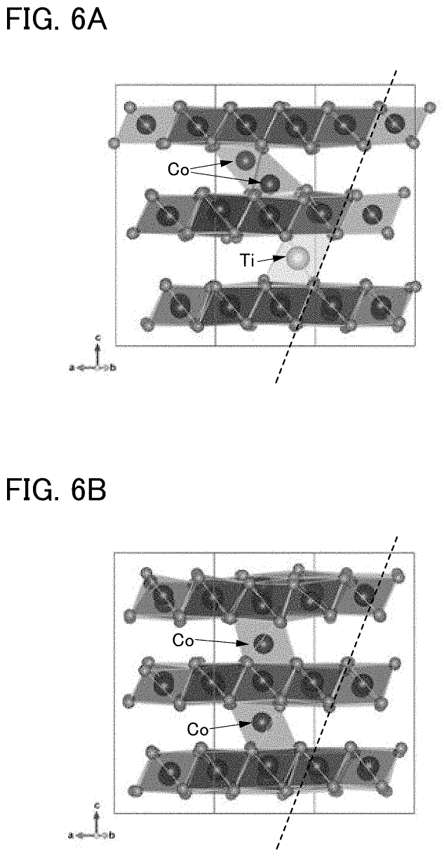

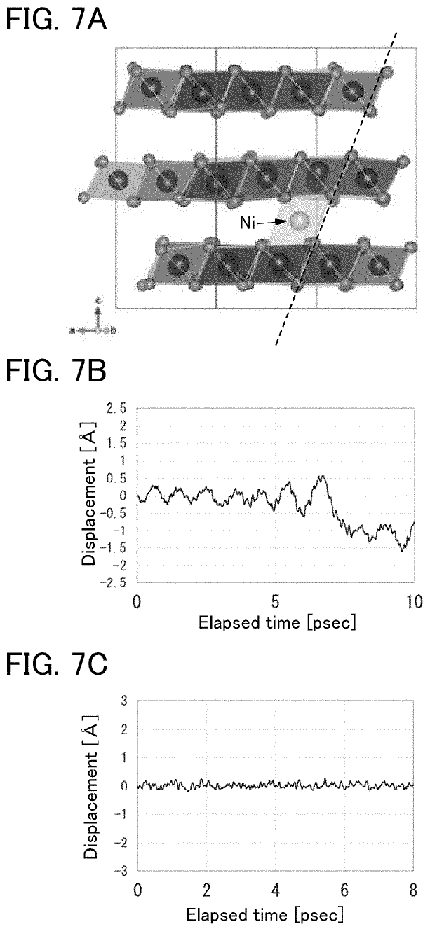

Calculation results after 8 ps at 600 K for the case where an atom is placed in the lithium layer are described below. FIG. 4B shows results for the case where a Mg atom is placed. FIG. 5A shows results for the case where a Li atom is placed. FIG. 5B shows results for the case where an Al atom is placed. FIG. 6A shows results for the case where a Ti atom is placed. FIG. 6B shows results for the case where a Co atom is placed. FIG. 7A shows results for the case where a Ni atom is placed. It is found that the crystal structure is stabilized with any of Al, Co, Ti, and Ni placed therein. It is found that Co goes out from the CoO₂ layer for the cases where Mg, Al, Ti, and Co are placed, suggesting that Co is unstable in LiCoO₂ from which lithium in the lithium layers is removed.

FIG. 7B shows displacement of Co in the CoO₂ layer in FIG. 3B. FIG. 7C shows displacement of Co in the CoO₂ layers in FIG. 7A. It is found that the crystal structure is stabilized when Ni is placed.

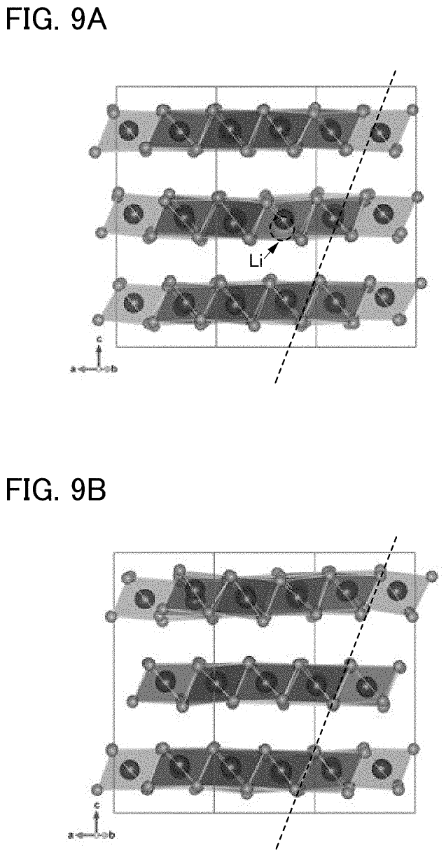

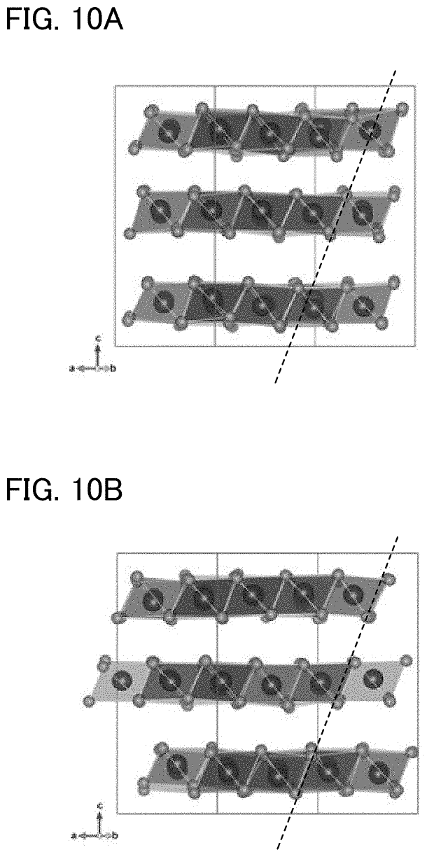

Next, calculation results after 10 ps at 600 K for the case where another atom is substituted for a Co atom in the CoO₂ layer are described below. FIG. 8B shows results for the case where a Mg atom is substituted. FIG. 9A shows results for the case where a Li atom is substituted. FIG. 9B shows results for the case where an Al atom is substituted. FIG. 10A shows results for the case where a Ti atom is substituted. FIG. 10B shows results for the case where a Ni atom is substituted. It is found that the crystal structure is stabilized when any of Al and Ni is substituted. Furthermore, it is found that Mg and Li go out from the CoO₂ layer, suggesting that they are unstable in the CoO₂ layer.

### <First Principles Calculation>

Stabilization energy ΔE was calculated using first principles calculation. ΔE is a value obtained by subtracting energy before substitution from energy after an element A is substituted in a Li position or a Co position in LiCoO₂.

A model in which one element A was substituted in a LiCoO₂ structure with 48 Li atoms, 48 Co atoms, and 96 O atoms was subjected to optimization of lattices and atomic positions with the use of first principles calculation.

Stabilization energy for the case where the element A is substituted for Li in the Li position can be represented as the following formula.

ΔE={Eₜₒₜₐₗ(A₁Li₄₇Co₄₈O₉₆)+Eₜₒₜₐₗ(Li)}−{Eₜₒₜₐₗ(Li₄₈Co₄₈O₉₆)+Eₜₒₜₐₗ(A)} [Formula 1]

Stabilization energy for the case where the element A is substituted for Co in the Co position can be represented as the following formula.

ΔE={Eₜₒₜₐₗ(A₁Li₄₈Co₄₇O₉₆)+Eₜₒₜₐₗ(Co)}−{Eₜₒₜₐₗ(Li₄₈CO₄₈O₉₆)+Eₜₒₜₐₗ(A)} [Formula 2]

Here, Eₜₒₜₐₗ(Li₄₈Co₄₈O₉₆) is the energy of 192 atoms of LiCoO₂, Eₜₒₜₐₗ(Li) is the energy of one isolated Li atom, Eₜₒₜₐₗ(Co) is the energy of one isolated Co atom, Eₜₒₜₐₗ(A₁Li₄₇Co₄₈O₉₆) is the energy of 192 atoms of the structure in which the element A is substituted in the Li site, and Eₜₒₜₐₗ(A₁Li₄₈Co₄₇O₉₆) is the energy of 192 atoms of the structure in which the element A is substituted in the Co site.

Using the first principles calculation, lattices and atomic positions are optimized with a layered rock-salt crystal structure and the R-3m space group to calculate the energies.

An example of results of the first principles calculation is shown below.

The conditions shown in Table 1 were used as the calculation conditions. A first principle electronic state calculation package, VASP, was used for the atomic relaxation calculation.

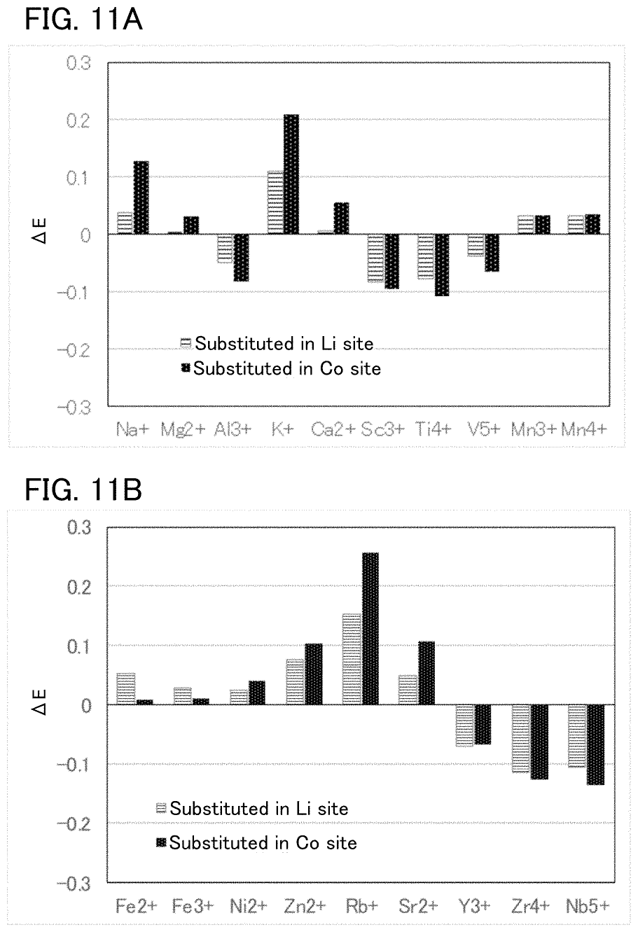

FIG. 11A shows ΔE calculated on the assumption that the element A is Na, Mg, Al, K, Ca, Sc, Ti, V, Mn (trivalence), or Mn (tetravalence), and FIG. 11B shows ΔE calculated on the assumption that the element A is Fe (divalence), Fe (trivalence), Ni, Zn, Rb, Sr, Y, Zr, or Nb.

As for Mg, ΔE becomes a positive value for both the cases of the substitution in the Li position and the substitution in the Co position, suggesting that Mg entering the crystal causes instability. As for Al, Ti, and the like, ΔE becomes a negative value, suggesting that Al, Ti, and the like entering the crystal provide stability.

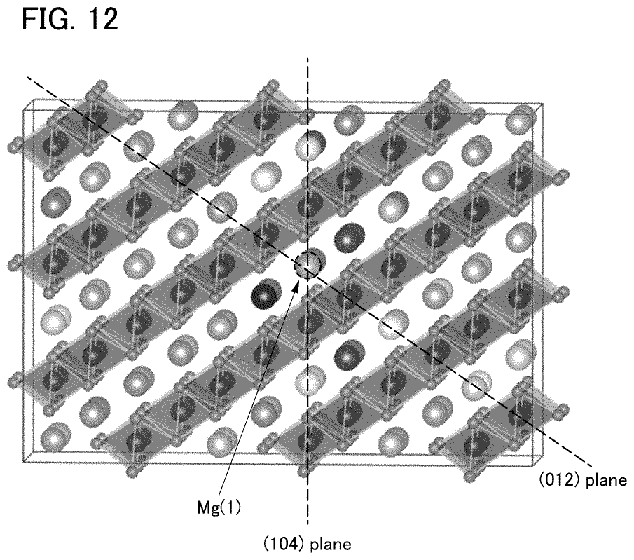

Next, stabilization energy for the case where two Mg atoms were substituted in the lithium layers was calculated. A first Mg atom was substituted in a position denoted by Mg(1) in FIG. 12. FIG. 12 shows stabilization energy for the case where a second Mg atom is placed in each position. FIG. 12 shows that for the substitution positions, the darker the color of the Mg atom has, the higher the instability becomes. It is suggested that the structure becomes unstable when the second Mg atom is placed in a direction along the CoO₂ layer with the Mg(1) position as the reference. It is also suggested that the structure becomes relatively stable when the second Mg atom is placed in a direction close to a direction perpendicular to the (001) plane that is a plane along the CoO₂ layer with the Mg(1) position as the reference. Note that dashed lines in the drawing denote a direction along the (012) plane and a direction along the (104) plane.

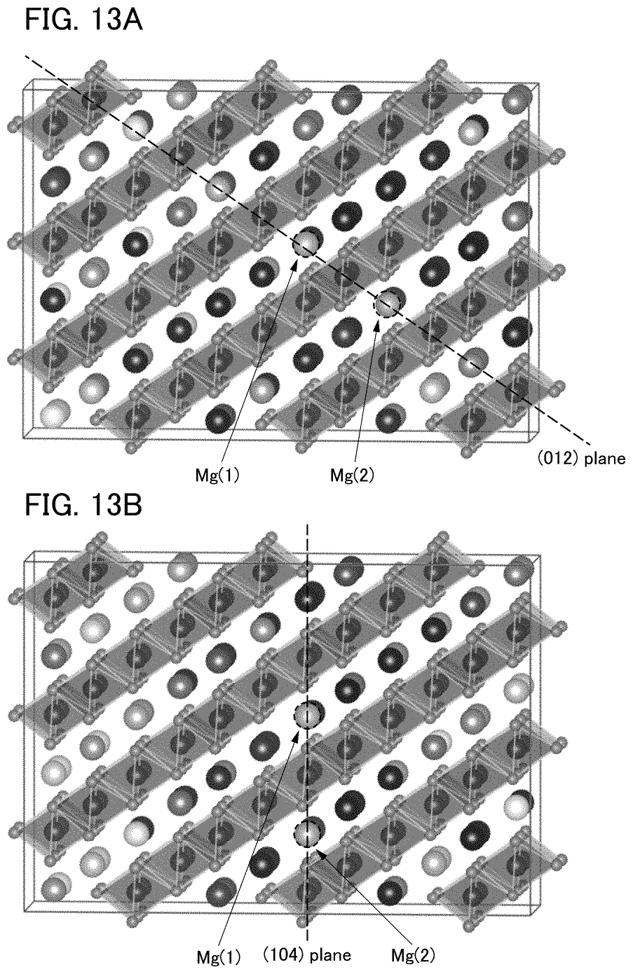

Next, stabilization energy for the case where three Mg atoms were substituted in the lithium layers was calculated. In FIG. 13A, a first Mg atom was substituted in a position denoted by Mg(1), and a second Mg atom was substituted in a position denoted by Mg(2) that is a position along the (012) plane. FIG. 13A shows stabilization energy for the case where a third Mg atom was placed in each position. FIG. 13A shows that for the substitution positions, the darker the color of the Mg atom has, the higher the instability becomes. It is suggested that the crystal structure becomes relatively stable for the case where the second Mg atom is placed in a direction close to a direction perpendicular to the (001) plane; as for other positions, the crystal structure becomes unstable for the case where the third Mg atom is substituted in a position that is close to the first and second Mg atoms to some extent.

FIG. 13B shows stabilization energy for the case where the first Mg atom is substituted in the position denoted by Mg(1), the second Mg atom is substituted in the position denoted by Mg(2) as a position along the (104) plane, and the third Mg atom is substituted in each position.

FIG. 13B shows that for the substitution positions, the darker the color of the Mg atom has, the higher the instability becomes. It is suggested that the crystal structure becomes unstable when the third Mg atom is substituted in a position that is close to the first and second Mg atoms to some extent.

The calculation results for ΔE by the first principles calculation shown in FIG. 12A, the calculation results by the quantum molecular dynamics calculation shown in FIG. 8B, and the calculation results by the first principles calculation shown in FIG. 13A and FIG. 13B indicate a possibility that Mg is unstable in a LiCoO₂ bulk. Thus, there is a possibility that Mg is more stable at a surface than in a LiCoO₂ bulk and contributes to structure stabilization in the surface. It is also suggested that Al and Ti are thermally stable and lead to an inhibition in phase change. Furthermore, it is suggested that Ni is also effective in inhibiting phase change.

Next, examination using quantum molecular dynamics calculation relating to a surface of LiCoO₂ will be described.

### <Quantum Molecular Dynamics 2>

A reaction of lithium fluoride, magnesium fluoride, and magnesium oxide with a surface of lithium cobalt oxide was examined by quantum molecular dynamics.

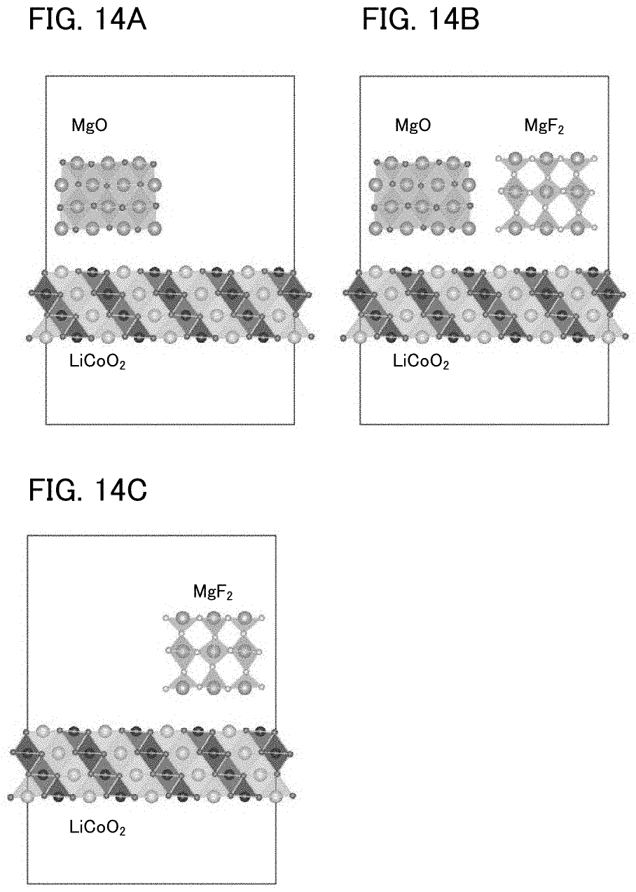

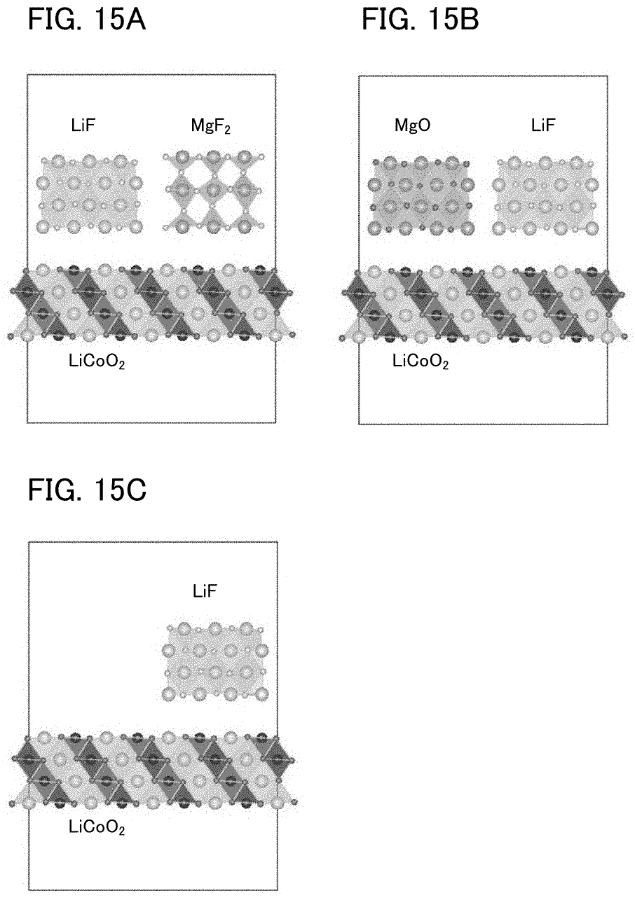

As the initial state of the calculation, six structural conditions illustrated in FIG. 14A, FIG. 14B, FIG. 14C, FIG. 15A, FIG. 15B, and FIG. 15C were prepared.

FIG. 14A, FIG. 14B, FIG. 14C, FIG. 15A, FIG. 15B, and FIG. 15C illustrate structures where substances are placed on a surface of LiCoO₂ on the assumption that the surface of LiCoO₂ is the (104) plane. FIG. 14A illustrates a structure where MgO is placed on the surface of LiCoO₂. FIG. 14B illustrates a structure where MgO and MgF₂ are placed on the surface of LiCoO₂. FIG. 14C illustrates a structure where MgF₂ is placed on the surface of LiCoO₂. FIG. 15A illustrates a structure where LiF and MgF₂ are placed on the surface of LiCoO₂. FIG. 15B illustrates a structure where MgO and LiF are placed on the surface of LiCoO₂. FIG. 15C illustrates a structure where LiF is placed on the surface of LiCoO₂.

The LiCoO₂ had a layered rock-salt structure of the space group R-3m. MgO and LiF each had a rock-salt structure of the space group Fm-3m and were placed so that the (100) plane faces the surface of the LCO. MgF₂ had a rutile structure of the space group P42/mnm and was placed so that the (110) plane faces the surface of the LCO.

A first principle electronic state calculation package, VASP, was used for the atomic relaxation calculation. The total number of atoms of the LiCoO₂ was 128. The calculation was performed under a temperature of 1200 K.

For other specific calculation conditions of the quantum molecular dynamics, the conditions shown in Table 1 were used.

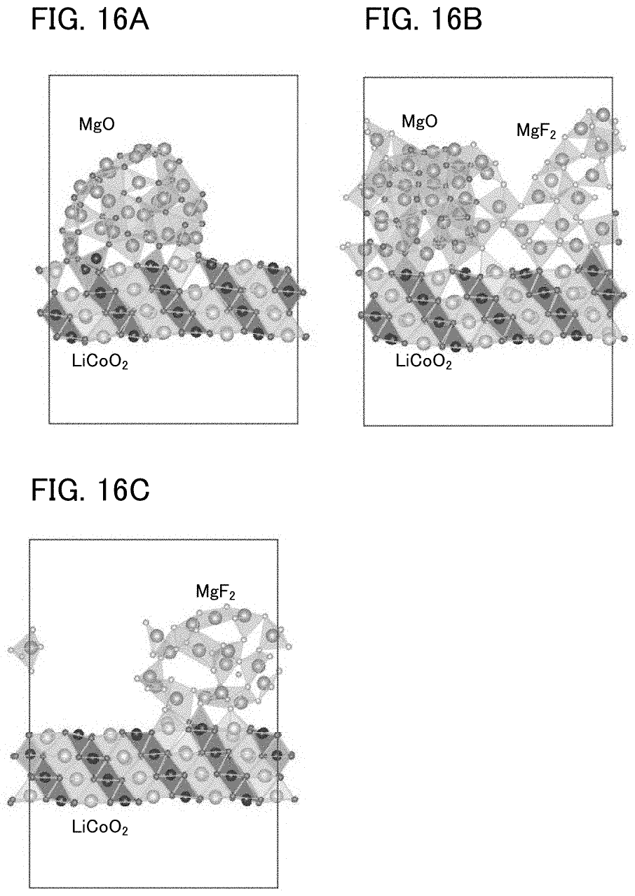

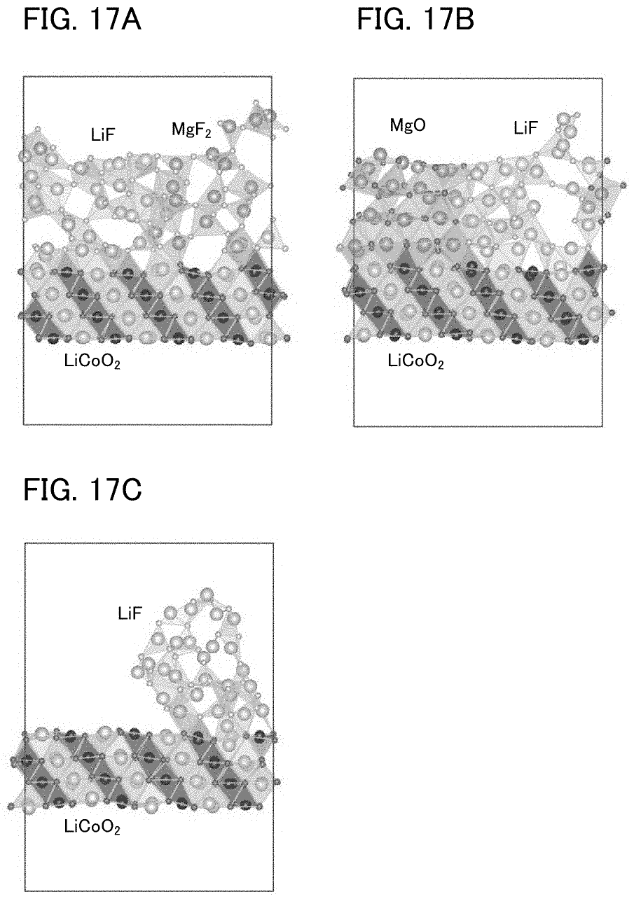

FIG. 16A, FIG. 16B, FIG. 16C, FIG. 17A, FIG. 17B, and FIG. 17C illustrate results after 1.42 ps. It is suggested that each of LiF and MgF₂ significantly changes its shape as compared to MgO and easily spreads on the surface of the LiCoO₂. FIG. 17A shows the state where LiF and MgF₂ are mixed, suggesting that reaction easily occurs.

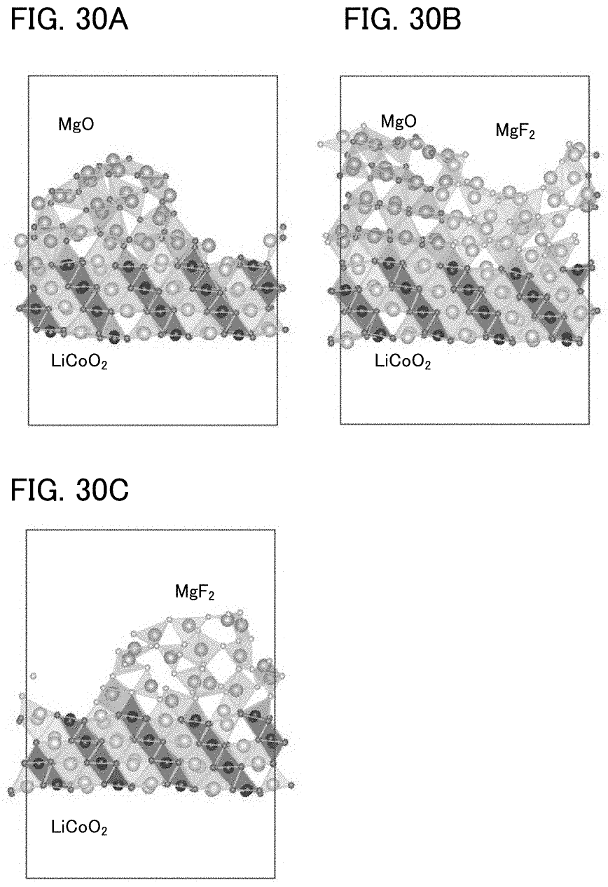

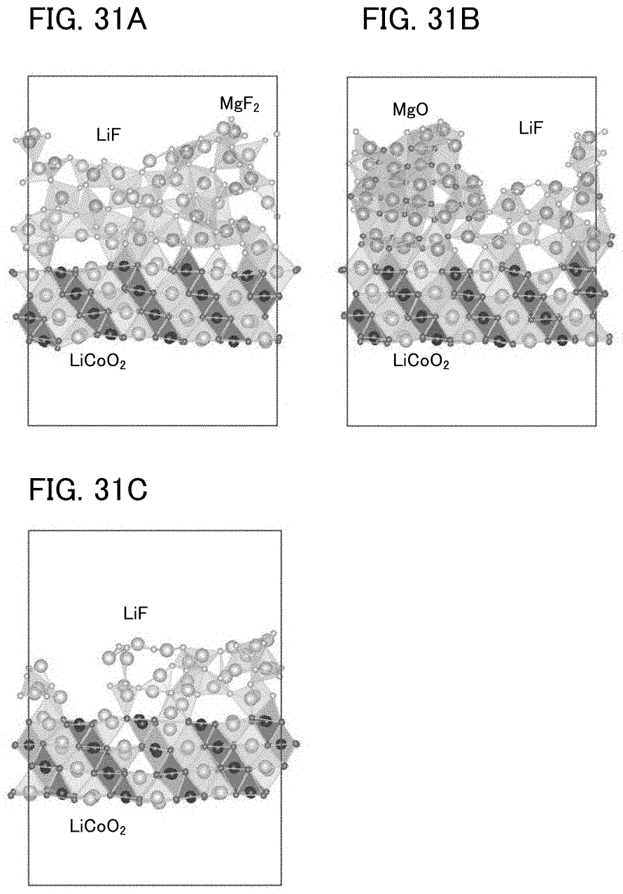

FIG. 30A, FIG. 30B, FIG. 30C, FIG. 31A, FIG. 31B, and FIG. 31C illustrate results after 10 ps. It is found from FIG. 30B that MgO covers MgF₂. It is found from FIG. 31A that LiF and MgF₂ are mixed more than in the result after 1.42 ps. It is found from FIG. 31C that LiF spreads slightly more widely as compared with FIG. 17C.

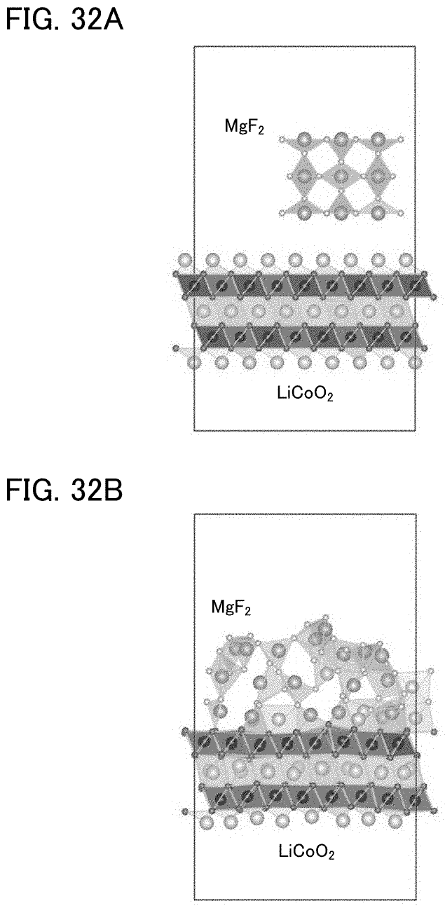

The results obtained by the quantum molecular dynamics calculation on the structures where the substances are placed on the surface of LiCoO₂ on the assumption that the surface of LiCoO₂ is the (104) plane have been illustrated in FIG. 16A, FIG. 16B, FIG. 16C, FIG. 17A, FIG. 17B, FIG. 17C, FIG. 30A, FIG. 30B, FIG. 30C, FIG. 31A, FIG. 31B, and FIG. 31C. Next, quantum molecular dynamics calculation was performed on a structure where MgF₂ was placed on the surface of LiCoO₂ on the assumption that the surface of LiCoO₂ is the (001) plane, which is shown in FIG. 32A. FIG. 32B illustrates results after 10 ps. It is suggested that MgF₂ spreads on the surface of LiCoO₂ more easily in FIG. 32B than in FIG. 30C. Furthermore, a reaction of oxygen of LiCoO₂ with MgF₂ is also suggested.

This embodiment can be freely combined with the other embodiments.

### EMBODIMENT 2

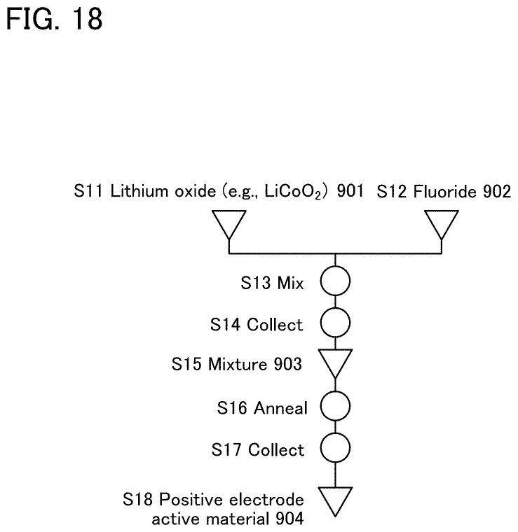

An example of a method for manufacturing LiMO₂ (M is two or more kinds of metals including Co, and the substitution positions of the metals are not particularly limited) is described with reference to FIG. 18. A positive electrode active material containing Mg as a metal element contained in LiMO₂ other than Co is described below as an example.

As a material for a lithium oxide 901, a composite oxide including lithium, a transition metal, and oxygen is used.

In the case where a composite oxide containing lithium, a transition metal, and oxygen that is synthesized in advance is used, a composite oxide with few impurities is preferably used. In this specification and the like, lithium, cobalt, nickel, manganese, aluminum, and oxygen are the main components of the composite oxide containing lithium, a transition metal, and oxygen and the positive electrode active material, and elements other than the main components are regarded as impurities. For example, when analyzed with a glow discharge mass spectroscopy method, the total impurity concentration is preferably less than or equal to 10,000 wt ppm, further preferably less than or equal to 5,000 wt ppm. In particular, the total impurity concentration of transition metals such as titanium and arsenic is preferably less than or equal to 3,000 wt ppm, further preferably less than or equal to 1,500 wt ppm.

For example, as the lithium cobalt oxide synthesized in advance, a lithium cobalt oxide particle (product name: CELLSEED C-10N) formed by NIPPON CHEMICAL INDUSTRIAL CO., LTD. can be used. This is lithium cobalt oxide in which the average particle diameter (D50) is approximately 12 μm, and in the impurity analysis by a glow discharge mass spectroscopy method (GD-MS), the magnesium concentration and the fluorine concentration are less than or equal to 50 wt ppm, the calcium concentration, the aluminum concentration, and the silicon concentration are less than or equal to 100 wt ppm, the nickel concentration is less than or equal to 150 wt ppm, the sulfur concentration is less than or equal to 500 wt ppm, the arsenic concentration is less than or equal to 1,100 wt ppm, and the concentrations of elements other than lithium, cobalt, and oxygen are less than or equal to 150 wt ppm.

The lithium oxide 901 in Step S11 preferably has a layered rock-salt crystal structure with few defects and distortions. Therefore, the composite oxide is preferably a composite oxide with few impurities. In the case where the composite oxide containing lithium, the transition metal, and oxygen includes a large number of impurities, the crystal structure is highly likely to have a large number of defects or distortions.

Furthermore, a fluoride 902 for Step S12 is prepared. In this embodiment, a lithium fluoride (LiF) is prepared as the fluoride 902. LiF is preferable because it has a cation common with LiCoO₂. LiF, which has a relatively low melting point of 848° C., is preferable because it is easily melted in an annealing process described later. MgF₂ may be used in addition to LiF. Fluorides that can be used in one embodiment of the present invention are not limited to LiF and MgF₂.

In addition, it is acceptable which Step S11 or Step S12 is performed first.

Next, mixing and grinding are performed in Step S13. Although the mixing can be performed by a dry process or a wet process, the wet process is preferable because the materials can be ground to a smaller size. When the mixing is performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, acetone is used.

For example, a ball mill, a bead mill, or the like can be used for the mixing. When the ball mill is used, a zirconia ball can be used as media, for example. The mixing and grinding steps are preferably performed sufficiently to pulverize a mixture 903.

The materials mixed and ground in the above manner are collected (Step S14 in FIG. 18), whereby the mixture 903 is obtained (Step S15 in FIG. 18).

For example, the D50 of the mixture 903 is preferably greater than or equal to 600 nm and less than or equal to 20 μm, further preferably greater than or equal to 1 μm and less than or equal to 10 μm.

Then, the mixture 903 is heated (Step S16 in FIG. 18). This step is referred to as annealing in some cases. LiMO₂ is produced by the annealing. Thus, the conditions of performing Step S16, such as temperature, time, an atmosphere, or weight of the mixture 903 to be annealed, are important. The meaning of annealing in this specification, includes a case where the mixture 903 is heated and a case where a heating furnace in which at least the mixture 903 is placed is heated. The heating furnace in this specification is equipment used for performing heat treatment (annealing) on a substance or a mixture and includes a heater unit, an atmosphere including a fluoride, and an inner wall that can withstand at least 600° C. Furthermore, the heating furnace may be provided with a pump having a function of reducing and/or increasing the inside pressure of the heating furnace. For example, pressure may be applied during the annealing in S16.

The annealing temperature in S16 is further preferably higher than or equal to the temperature at which the mixture 903 melts. The annealing temperature needs to be lower than or equal to a decomposition temperature of LiCoO₂ (1130° C.). Since the decomposition temperature of LiCoO₂ is 1130° C., decomposition of a slight amount of LiCoO₂ is concerned at a temperature close to the decomposition temperature. Thus, the annealing temperature is preferably lower than or equal to 1130° C., and is lower than or equal to 1000° C.

LiF is used as the fluoride 902 and the annealing in S16 is conducted with the lid put on, whereby the positive electrode active material 904 with favorable cycle characteristics and the like can be manufactured. It is considered that when LiF and MgF₂ are used as the fluoride 902, the reaction with LiCoO₂ is promoted with the annealing temperature in S16 set to be higher than or equal to 742° C. to generate LiMO₂ because the eutectic point of LiF and MgF₂ is around 742° C.

Furthermore, an endothermic peak of LiF, MgF₂, and LiCoO₂ is observed at around 820° C. by differential scanning calorimetry (DSC measurement). Thus, the annealing temperature is preferably higher than or equal to 742° C., further preferably higher than or equal to 820° C.

Accordingly, the annealing temperature is preferably higher than or equal to 742° C. and lower than or equal to 1130° C., further preferably higher than or equal to 742° C. and lower than or equal to 1000° C. Moreover, the annealing temperature is preferably higher than or equal to 820° C. and lower than or equal to 1130° C., further preferably higher than or equal to 820° C. and lower than or equal to 1000° C.

In this embodiment, LiF, which is a fluoride, is considered to function as flux. Accordingly, since the capacity of the heating furnace is larger than the capacity of the container and LiF is lighter than oxygen, it is expected that LiF is volatilized and the reduction of LiF in the mixture 903 inhibits production of LiMO₂. Therefore, heating needs to be performed while volatilization of LiF is inhibited.

Thus, when the mixture 903 is heated in an atmosphere including LiF, that is, the mixture 903 is heated in a state where the partial pressure of LiF in the heating furnace is high, volatilization of LiF in the mixture 903 is inhibited. By performing annealing using the fluoride (LiF or MgF) to form an eutectic mixture with the lid put on, the annealing temperature can be lowered to the decomposition temperature of the LiCoO₂ (1130° C.) or lower, specifically, a temperature higher than or equal to 742° C. and lower than or equal to 1000° C., thereby enabling the production of LiMO₂ to progress efficiently. Accordingly, a positive electrode active material having favorable characteristics can be formed, and the annealing time can be reduced.

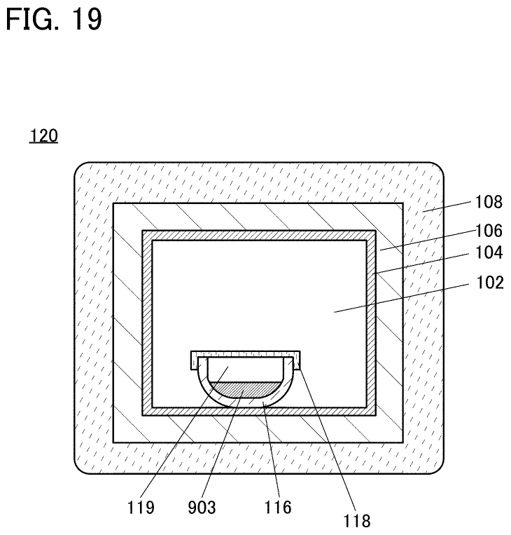

FIG. 19 illustrates an example of the annealing method in S16.

A heating furnace 120 illustrated in FIG. 19 includes a space 102 in the heating furnace, a hot plate 104, a heater unit 106, and a heat insulator 108. It is further preferable to put a lid 118 on a container 116 in annealing. With this structure, an atmosphere including a fluoride can be obtained in a space 119 enclosed by the container 116 and the lid 118. In the annealing, the state of the space 119 is maintained with the lid put on so that the concentration of the gasified fluoride inside the space 119 can be constant or cannot be reduced, in which case fluorine or magnesium can be contained in the vicinity of the particle surface or in a surface portion of the particle. The atmosphere including a fluoride can be provided in the space 119, which is smaller in capacity than the space 102 in the heating furnace, by volatilization of a smaller amount of a fluoride. This means that an atmosphere including a fluoride can be provided in the reaction system without a significant reduction in the amount of a fluoride included in the mixture 903. Accordingly, LiMO₂ can be produced efficiently. In addition, the use of the lid 118 allows the annealing of the mixture 903 in an atmosphere including a fluoride to be simply and inexpensively performed.

Furthermore, the fluoride or the like attached to inner walls of the container 116 and the lid 118 is likely to be fluttered again by the heating and attached to the mixture 903.

Here, the valence number of Co (cobalt) in LiMO₂ formed by one embodiment of the present invention is preferably approximately 3. The valence number of cobalt can be 2 or 3. Thus, to inhibit reduction of cobalt, it is preferable that the atmosphere in the space 102 in the heating furnace include oxygen, the ratio of oxygen to nitrogen in the atmosphere in the space 102 in the heating furnace be higher than or equal to that in the air atmosphere, and the oxygen concentration in the atmosphere in the space 102 in the heating furnace be higher than or equal to that in the air atmosphere. Thus, an atmosphere including oxygen needs to be introduced into the space in the heating furnace

Thus, in one embodiment of the present invention, before heating is performed, a step of providing an atmosphere including oxygen in the space 102 in the heating furnace and a step of placing the container 116 in which the mixture 903 is placed in the space 102 in the heating furnace are performed. The steps in this order enable the mixture 903 to be annealed in an atmosphere including oxygen and a fluoride. During the annealing, the space 102 in the heating furnace is preferably sealed to prevent any gas from being discharged to the outside. For example, it is preferable that no gas flows during the annealing.

Although there is no particular limitation on the method of providing an atmosphere including oxygen in the space 102 in the heating furnace, examples are a method of introducing an oxygen gas or a gas containing oxygen such as dry air after exhausting air from the space 102 in the heating furnace and a method of flowing an oxygen gas or a gas containing oxygen such as dry air into the space 102 for a certain period of time. In particular, introducing an oxygen gas after exhausting air from the space 102 in the heating furnace (oxygen displacement) is preferred. Note that the atmosphere of the space 102 in the heating furnace may be regarded as an atmosphere including oxygen.

There is no particular limitation on the step of heating the heating furnace 120. The heating may be performed using a heating mechanism included in the heating furnace 120.

Although there is no particular limitation on the way of placing the mixture 903 in the container 116, as illustrated in FIG. 19, the mixture 903 is preferably provided so that the top surface of the mixture 903 is flat on the bottom surface of the container 116, in other words, the level of the top surface of the mixture 903 becomes uniform.

The annealing in Step S16 is preferably performed at an appropriate temperature for an appropriate time. The appropriate temperature and time change depending on the conditions such as the particle size and the composition of the particle of the lithium oxide 901 in Step S11. In the case where the particle size is small, the annealing is preferably performed at a lower temperature or for a shorter time than the case where the particle size is large, in some cases. After the annealing in S16, a step of removing the lid is performed.

For example, in the case where the average particle diameter (D50) of particles in Step S11 is approximately 12 μm, the annealing time is preferably 3 hours or longer, further preferably 10 hours or longer.

By contrast, in the case where the average particle diameter (D50) of particles in Step S11 is approximately 5 μm, the annealing time is preferably longer than or equal to 1 hour and shorter than or equal to 10 hours, further preferably approximately 2 hours, for example.

The temperature decreasing time after the annealing is, for example, preferably longer than or equal to 10 hours and shorter than or equal to 50 hours.

The materials annealed in the above manner are collected (Step S17 in FIG. 18), whereby the positive electrode active material 904 is obtained (Step S18 in FIG. 18).

Here, in the annealing in S16, the difference between a particle obtained by annealing using the lid and a particle obtained by annealing without using the lid, which is a comparative example, is described next.

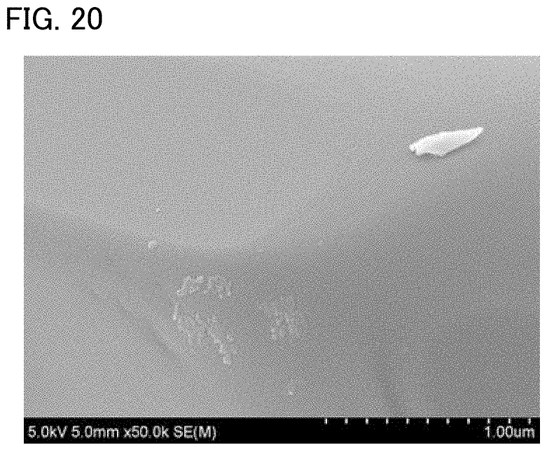

FIG. 20 shows an example of a cross-sectional image of one of the positive electrode active material particles subjected to annealing using the lid, which is obtained with a SEM.

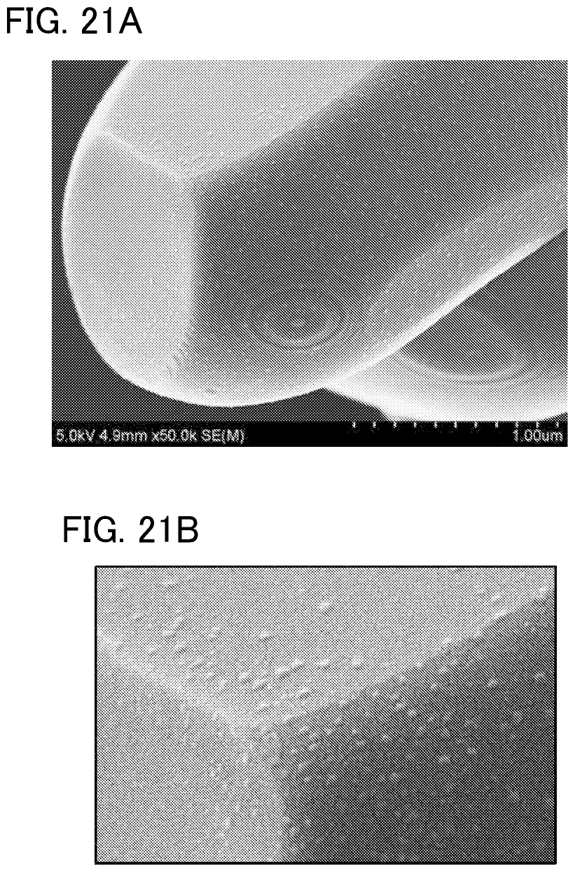

FIG. 21B is an enlarged view of a part of FIG. 21A that is the comparative example. It is found that the surface of the particle in FIG. 20 is smoother than that in FIG. 21A and FIG. 21B.

This embodiment can be freely combined with the other embodiments.

### EMBODIMENT 3

In this embodiment, an example of manufacturing a battery cell using LiMO₂ formed by the manufacturing method of one embodiment of the present invention will be described. Since many parts are common, a manufacturing method thereof is described with reference to FIG. 18.

Lithium cobalt oxide is prepared as the oxide 901. Specifically, CELLSEED C-10N manufactured by NIPPON CHEMICAL INDUSTRIAL CO., LTD. is prepared (Step S11).

LiF and MgF₂ are prepared for the fluoride 902. LiF and MgF₂ are weighted so that the molar ratio of LiF to MgF₂ is LiF:MgF₂=1:3, acetone is added as a solvent, and the materials are mixed and ground by a wet process. LiF to lithium cobalt oxide is set to 0.17 mol %. MgF₂ to lithium cobalt oxide is set to 0.5 mol %.

The lithium oxide 901 and the fluoride 902 are mixed and collected to give the mixture 903.

Then, the mixture 903 is put in a container and a lid is put on the container. The inside of the heating furnace is set to an oxygen atmosphere and annealing is performed. The annealing temperature might be different depending on the weight of the mixture 903, but is preferably higher than or equal to 742° C. and less than or equal to 1000° C. An annealing temperature is a temperature at the time of the annealing, and “annealing time” is time for holding the annealing temperature. The temperature rising rate is 200° C./h, and the temperature decreasing time is longer than or equal to 10 hours. It is preferable that the space 102 in the heating furnace be sealed during the annealing to prevent any gas from being discharged to the outside. For example, it is preferable that no gas flows during the annealing.

In this embodiment, the annealing temperature of 850° C., 60 hours, and an oxygen atmosphere in the heating furnace are employed.

After the annealing, the positive electrode active material 904 can be collected. When a surface without unevenness is obtained, the lid may be removed during the heating for cooling. After the cooling, the lid is removed and the obtained positive electrode active material 904 is used to form each positive electrode. A current collector that is coated with slurry in which the positive electrode active material, acetylene black (AB), and polyvinylidene fluoride (PVDF) are mixed at the active material:AB:PVDF=95:3:2 (weight ratio) is used. As a solvent of the slurry, NMP is used.

After the current collector is coated with the slurry, the solvent is volatilized. Then, pressure is applied at 210 kN/m, and then pressure is applied at 1467 kN/m. Through the above process, the positive electrode is obtained. The carried amount of the positive electrode is approximately 7 mg/cm², and the electrode density is >3.8 g/cc.

Using the formed positive electrodes, CR2032 type coin battery cells (a diameter of 20 mm, a height of 3.2 mm) are formed.

A lithium metal is used for a counter electrode.

As an electrolyte included in the electrolyte solution, 1 mol/L lithium hexafluorophosphate (LiPF₆) is used. As the electrolyte solution, an electrolyte solution in which ethylene carbonate (EC) and diethyl carbonate (DEC) are mixed at EC:DEC=3:7 (volume ratio) is used. Note that 2 wt % vinylene carbonate (VC) is added to the electrolyte solution.

As a separator, 25-μm-thick polypropylene is used.

A positive electrode can and a negative electrode can that are formed using stainless steel (SUS) are used.

Through the above steps, a secondary battery cell can be manufactured.

The comparison results of experiments conducted under different annealing conditions are shown below.

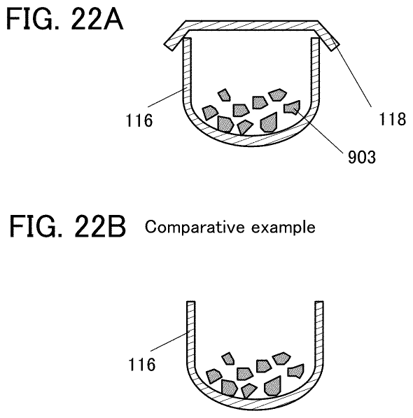

FIG. 22A illustrates a condition that is the same as the above-described manufacturing method and is the same as FIG. 19, using the same reference numerals in FIG. 19. The same material, specifically, a ceramics material, is used for the container and the lid. The lid is larger than the opening of the container, and the lid is set by its self-weight. No gap is preferred between the lid and the container as much as possible, but the lid has a gap to prevent the inside of the container from being airtight with the lid.

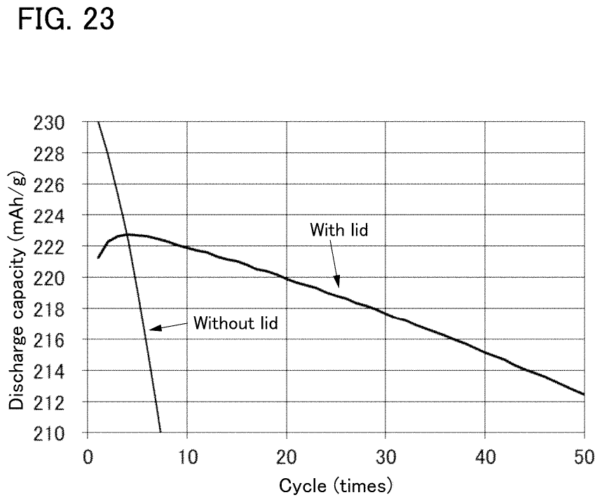

FIG. 23 shows cycle characteristics of the battery cell. The cycle characteristics were evaluated at 25° C. while the CCCV charging (0.5 C, 4.6 V, termination current of 0.05 C) and the CC discharging (0.5 C, 2.5 V) were performed. FIG. 23 shows the results.

FIG. 23 also shows cycle characteristics of a battery cell manufactured by the same manufacturing procedure under the same conditions except that a lid is put not as illustrated in FIG. 22B, as a comparative example.

From the above, it can be confirmed that the condition for the annealing using a lid shows favorable cycle characteristics compared with the comparative example under the annealing condition without using a lid.

This embodiment can be freely combined with the other embodiments.

### EMBODIMENT 4

In this embodiment, examples of the shape of a secondary battery including the positive electrode active material manufactured by the manufacturing method described in the above embodiment are described. For the materials used for the secondary battery described in this embodiment, the description of the above embodiment can be referred to.

### [Coin-Type Secondary Battery]

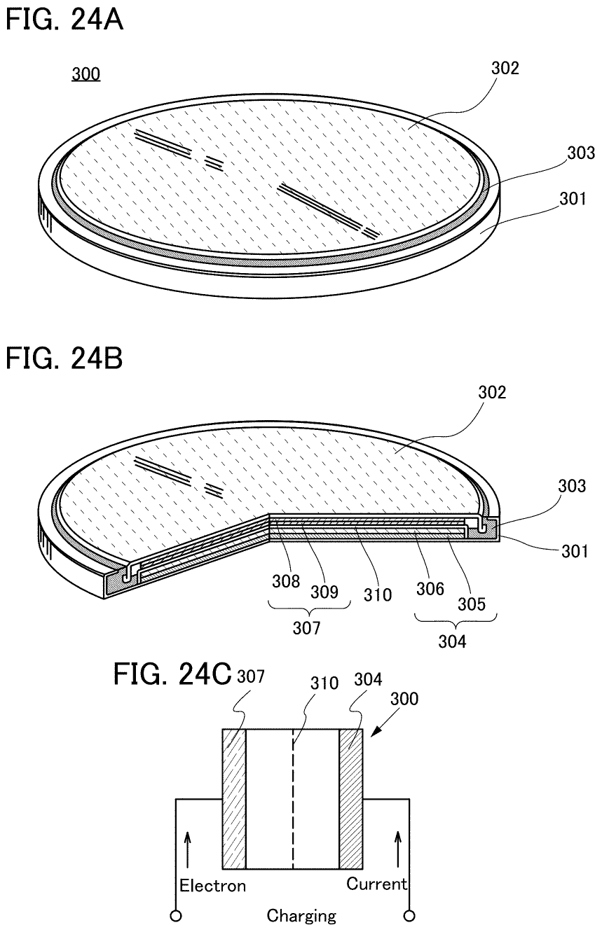

An example of a coin-type secondary battery is described. FIG. 24A is an external view of a coin-type (single-layer flat type) secondary battery, and FIG. 24B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and a separator 310 are immersed in the electrolyte solution; as illustrated in FIG. 24B, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

When the positive electrode active material particle described in the above embodiments is used in the positive electrode 304, the coin-type secondary battery 300 with little deterioration and high safety can be obtained.

Carbon-based materials such as graphite, graphitizing carbon, non-graphitizing carbon, a carbon nanotube, carbon black, and a graphene compound can be used as the negative electrode active material. In addition, a metal or a compound including one or more elements selected from silicon, tin, gallium, aluminum, germanium, lead, antimony, bismuth, silver, zinc, cadmium, and indium, can be used as the negative electrode active material. Furthermore, an oxide including one or more elements selected from titanium, niobium, tungsten, and molybdenum can be used as the negative electrode active material.

### [Separator]

The secondary battery preferably includes a separator. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably formed to have an envelope-like shape to wrap one of the positive electrode and the negative electrode.

The separator may have a multilayer structure. For example, an organic material film such as polypropylene or polyethylene can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

Deterioration of the separator in high-voltage charge and discharge can be inhibited and thus the reliability of the secondary battery can be improved because oxidation resistance is improved when the separator is coated with the ceramic-based material. In addition, when the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of the polypropylene film that is in contact with the positive electrode may be coated with the mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

Here, a current flow in charging a secondary battery is described with reference to FIG. 24C. When a secondary battery using lithium is regarded as a closed circuit, lithium ions transfer and a current flows in the same direction. Note that in a secondary battery using lithium, the anode and the cathode are interchanged in charging and discharging, and the oxidation reaction and the reduction reaction are interchanged; thus, an electrode with a high reaction potential is called the positive electrode and an electrode with a low reaction potential is called the negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charge current is supplied. The use of terms such as anode and cathode related to oxidation reaction and reduction reaction might cause confusion because the anode and the cathode are reversed in charging and in discharging. Thus, the terms such as anode and cathode are not used in this specification. If the term such as an anode or a cathode is used, whether it is at the time of charge or discharge is noted and whether it corresponds to a positive electrode or a negative electrode is also noted.

Two terminals illustrated in FIG. 24C are connected to a charger, and the secondary battery 300 is charged. As the charge of the secondary battery 300 proceeds, a potential difference between electrodes increases.

### [Cylindrical Secondary Battery]

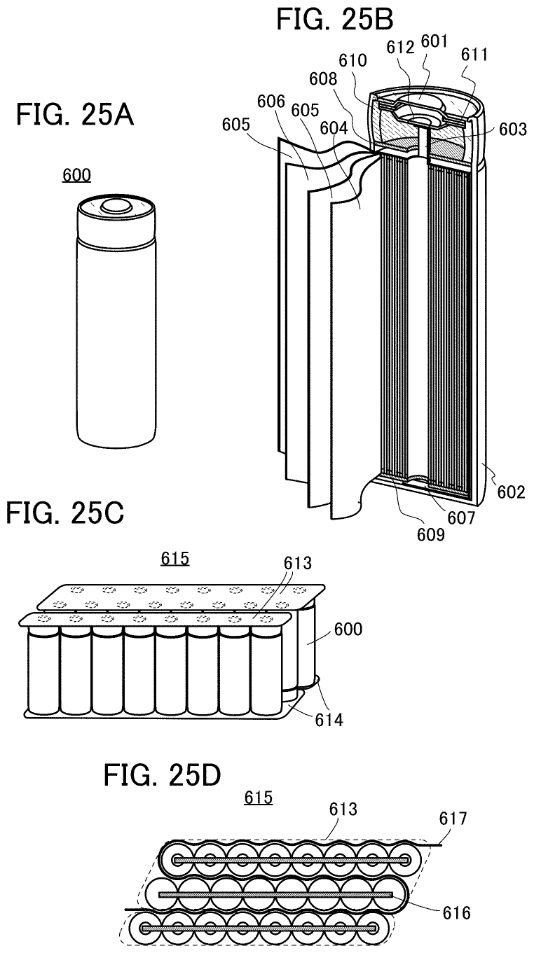

An example of a cylindrical secondary battery is described with reference to FIG. 25A to FIG. 25D. As illustrated in FIG. 25A, the cylindrical secondary battery 600 includes a positive electrode cap (battery lid) 601 on a top surface and a battery can (outer can) 602 on a side surface and a bottom surface. The positive electrode cap and the battery can (outer can) 602 are insulated from each other by a gasket (insulating gasket) 610.

FIG. 25B is a schematic cross-sectional view of a cylindrical secondary battery. Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is closed and the other end thereof is opened. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel or aluminum, for example, in order to prevent corrosion due to the electrolyte solution. Inside the battery can 602, the battery element in which the positive electrode, the negative electrode, and the separator are wound is provided between a pair of insulating plates 608 and 609 that face each other. Furthermore, the inside of the battery can 602 provided with the battery element is filled with a nonaqueous electrolyte solution (not illustrated). As the nonaqueous electrolyte solution, an electrolyte solution similar to that for the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. In addition, the PTC element 611 is a thermally sensitive resistor whose resistance increases as temperature rises, and limits the amount of current by increasing the resistance to prevent abnormal heat generation. Barium titanate (BaTiO₃)-based semiconductor ceramics or the like can be used for the PTC element.

As illustrated in FIG. 25C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 25D is a top view of the module 615. The conductive plate 613 is shown by a dotted line for clarity of the drawing. As illustrated in FIG. 25D, the module 615 may include a conductive wire 616 electrically connecting the plurality of secondary batteries 600 with each other. The conductive plate can be provided over the conductive wire 616 to overlap the conductive wire 616. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be influenced by the outside temperature.

When the positive electrode active material formed by the forming method described in the above embodiment is used in the positive electrode 604, the cylindrical secondary battery 600 with little deterioration and high safety can be obtained.

### [Structure Examples of Secondary Battery]

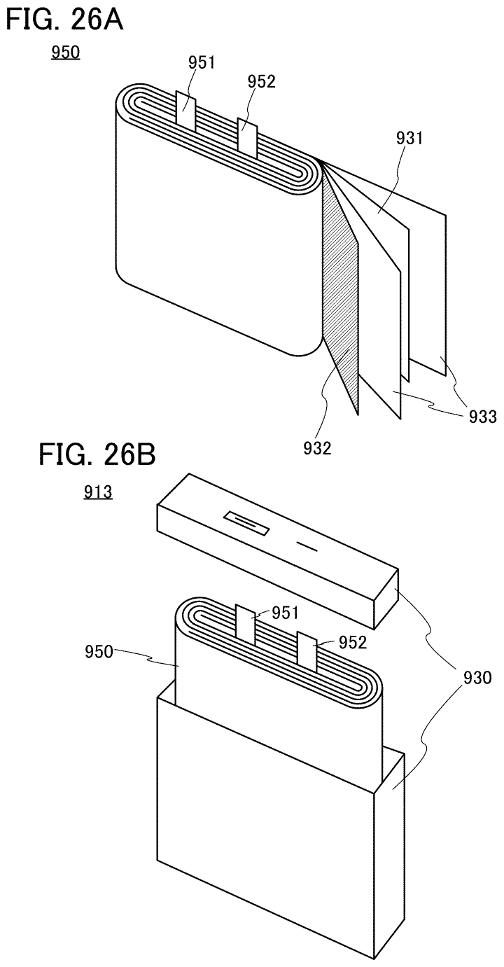

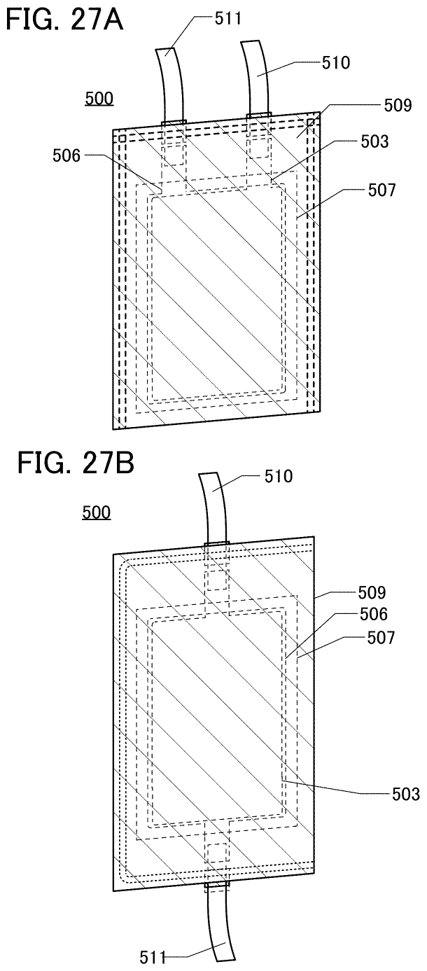

Other structural examples of power storage devices will be described with reference to FIG. 26 and FIG. 27.

FIG. 26A illustrates a structure of a wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks of the negative electrode 931, the positive electrode 932, and the separator 933 may be further overlaid.

The secondary battery 913 illustrated in FIG. 26B includes a wound body 950 provided with the terminal 951 and the terminal 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 26B, the housing 930 that has been divided is illustrated for convenience; however, in reality, the wound body 950 is covered with the housing 930, and the terminal 951 and the terminal 952 extend to the outside of the housing 930. For the housing 930, a metal material (e.g., aluminum) or a resin material can be used.

### [Laminated Secondary Battery>

Next, an example of a laminated secondary battery is described with reference to FIG. 27A and FIG. 27B.

FIG. 27A illustrates an example of an external view of a laminated secondary battery 500. FIG. 27B illustrates another example of an external view of the laminated secondary battery 500.

In FIG. 27A and FIG. 27B, the positive electrode 503, the negative electrode 506, the separator 507, the exterior body 509, a positive electrode lead electrode 510, and a negative electrode lead electrode 511 are included.

The laminated secondary battery 500 includes a wound body or a plurality of positive electrodes 503, separators 507, and negative electrodes 506 that are each strip-shaped.

The wound body includes the negative electrode 506, the positive electrode 503, and the separator 507. The wound body is, like the wound body illustrated in FIG. 26A, obtained by winding a sheet of a stack in which the negative electrode 506 overlaps with the positive electrode 503 with the separator 507 provided therebetween.

The secondary battery may include the plurality of positive electrodes 503, separators 507, and negative electrodes 506 that are each strip-shaped in a space formed by a film serving as the exterior body 509.

A manufacturing method of the secondary battery including the plurality of positive electrodes 503, separators 507, and negative electrodes 506 that are each strip-shaped is described below.

First, the negative electrodes 506, the separators 507, and the positive electrodes 503 are stacked. This embodiment describes an example using five negative electrodes and four positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrodes 506, the separators 507, and the positive electrodes 503 are placed over the exterior body 509.

As the exterior body 509, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

The exterior body 509 is folded to interpose the stack therebetween. Then, the outer edges of the exterior body 509 are bonded to each other. The bonding can be performed by thermocompression, for example. In this bonding, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert gas atmosphere. Lastly, the inlet is sealed by bonding. In the above manner, the laminated secondary battery 500 can be manufactured.

When the positive electrode active material particle described in the above embodiment is used in the positive electrode 503, the secondary battery 500 with little deterioration and high safety can be obtained.

This embodiment can be freely combined with the other embodiments.

### EMBODIMENT 5

In this embodiment, a structure of a solid secondary battery will be described. In this specification, not only a secondary battery including only a solid electrolyte but also a secondary battery including a polymer gel electrolyte, a few amount of electrolyte, or a combination thereof is also referred to as a solid battery.

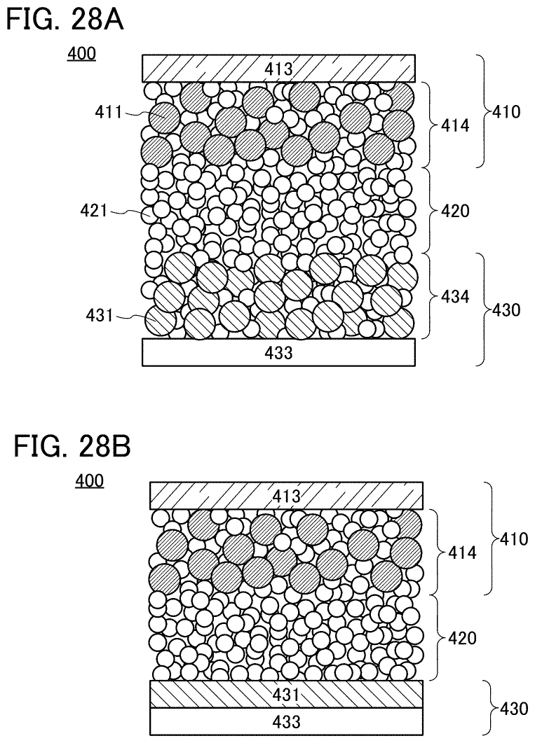

As illustrated in FIG. 28A, a secondary battery 400 that is the solid battery of one embodiment of the present invention includes a positive electrode 410, a solid electrolyte layer 420, and a negative electrode 430. FIG. 28A illustrates a case of using a solid electrolyte. When the solid electrolyte is used, a separator and a spacer are not necessary. Furthermore, the battery can be entirely solidified; therefore, there is no possibility of liquid leakage and thus the safety is dramatically increased.

The positive electrode 410 includes a positive electrode current collector 413 and a positive electrode active material layer 414. The positive electrode active material layer 414 includes a positive electrode active material 411 and a solid electrolyte 421. As the positive electrode active material, the positive electrode active material 904 described in the above embodiment can be used. The positive electrode active material layer 414 may also include a conductive material and a binder. As the conductive material, a carbon material such as carbon black (e.g., AB), graphite (black lead) particles, carbon nanotubes (CNT), or fullerene can be used. Alternatively, metal powder or metal fibers of copper, nickel, aluminum, silver, gold, or the like, a conductive ceramic material, or the like can be used. Alternatively, a graphene compound may be used as the conductive material. A graphene compound has excellent electrical characteristics of high conductivity and excellent physical properties of high flexibility and high mechanical strength in some cases. A graphene compound has a planar shape. A graphene compound enables low-resistance surface contact. Furthermore, a graphene compound has extremely high conductivity even with a small thickness in some cases and thus allows a conductive path to be formed in an active material layer efficiently even with a small amount. Hence, a graphene compound is preferably used as a conductive additive, in which case the area where the active material and the conductive additive are in contact with each other can be increased. In addition, a graphene compound is preferable because electrical resistance can be reduced in some cases. Here, examples of the graphene compound include graphene, multilayer graphene, multi graphene, graphene oxide, multilayer graphene oxide, multi graphene oxide, graphene oxide that is reduced, multilayer graphene oxide that is reduced, multi graphene oxide that is reduced, and graphene quantum dots. The graphene oxide that is reduced is also referred to as reduced graphene oxide (hereinafter RGO). Note that RGO refers to a compound obtained by reducing graphene oxide (GO), for example. In the case where an active material particle with a small particle diameter, e.g., 1 μm or less, is used, the specific surface area of the active material particle is large and thus more conductive paths for connecting the active material particles are needed. In such a case, a graphene compound that can efficiently form a conductive path even in a small amount is particularly preferably used. In this specification and the like, graphene oxide contains carbon and oxygen, has a sheet-like shape, and includes a functional group, in particular, an epoxy group, a carboxy group, or a hydroxy group. When a plurality of graphene compounds are bonded to each other, a net-like graphene compound sheet (hereinafter referred to as a graphene compound net or a graphene net) can be formed. The graphene net covering the active material can function as a binder for bonding active materials. The amount of binder can thus be reduced, or the binder does not have to be used. This can increase the proportion of the active material in the electrode volume or the electrode weight. That is, the capacity of the secondary battery can be increased.

The solid electrolyte layer 420 includes the solid electrolyte 421. The solid electrolyte layer 420 is positioned between the positive electrode 410 and the negative electrode 430, and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive material and a binder. Note that when metal lithium is used for the negative electrode 430, it is possible that the negative electrode 430 does not include the solid electrolyte 421 as illustrated in FIG. 28B. The use of metallic lithium for the negative electrode 430 is preferable because the energy density of the secondary battery 400 can be increased. Note that in FIG. 28A and FIG. 28B, the solid electrolyte 421, the positive electrode active material 411, and the negative electrode active material 431 have spherical shapes as ideal particle shapes; however, they actually have various shapes, and thus the shapes are schematically illustrated in the drawings for convenience.

As materials for the solid electrolyte 421 included in the solid electrolyte layer 420 and the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂Si₂ and Li_{3.25}Ge_{0.25}P_{0.75}S₄), sulfide glass (e.g., 70Li₂S.30P₂S₅, 30Li₂S.26B₂S₃.44LiI, 63Li₂S.38SiS₂.1Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a conduction path after charge and discharge because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-X}Al_{X}Ti_{2-X}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Note that in this specification and the like, a material with a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

Alternatively, an electrolyte solution may be mixed.

As the electrolyte solution that is mixed with a solid electrolyte, an electrolyte solution that is highly purified and contains small numbers of dust particles and elements other than the constituent elements of the electrolyte solution (hereinafter also simply referred to as “impurities”) is preferably used. Specifically, the weight ratio of impurities to the electrolyte solution is preferably less than or equal to 1%, further preferably less than or equal to 0.1%, still further preferably less than or equal to 0.01%.

An additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution that is mixed with the solid electrolyte. The concentration of a material to be added in the whole solvent is, for example, higher than or equal to 0.1 wt % and lower than or equal to 5 wt %.

As the material mixed with the solid electrolyte, a polymer gel electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

This embodiment can be freely combined with the other embodiments.

### EMBODIMENT 6

In this embodiment, examples of electronic devices or a vehicle each using the secondary battery of one embodiment of the present invention will be described.

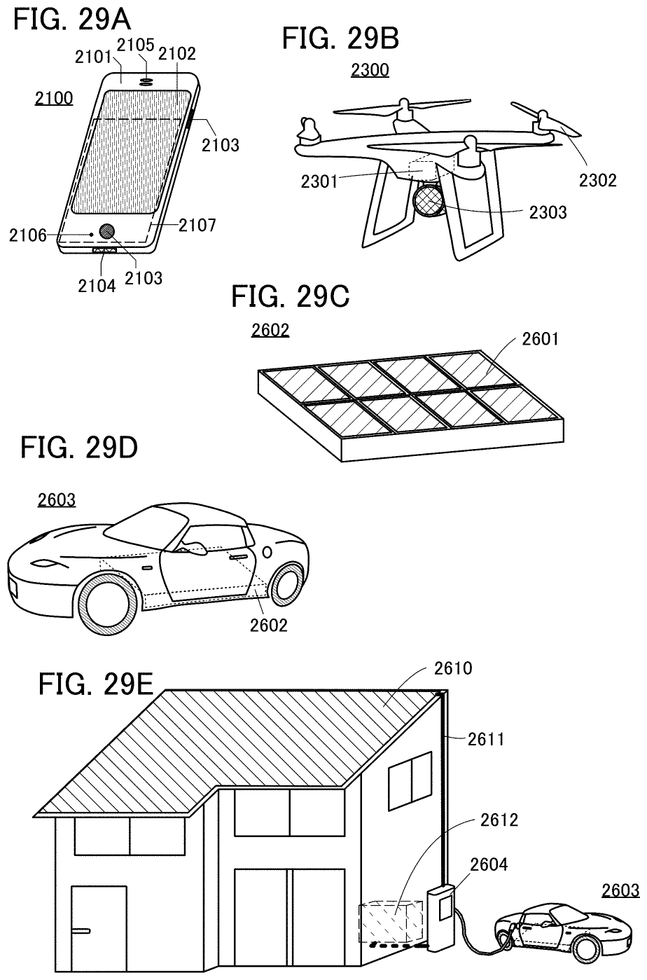

First, FIG. 29A to FIG. 29E show examples of electronic devices each including the secondary battery described in part of Embodiment 5. Examples of electronic devices each including the bendable secondary battery include television devices (also referred to as televisions or television receivers), monitors for computers and the like, digital cameras, digital video cameras, digital photo frames, mobile phones (also referred to as cellular phones or mobile phone devices), portable game machines, portable information terminals, audio reproducing devices, and large game machines such as pachinko machines.

The secondary battery can also be used in moving vehicles, typically automobiles. Examples of the automobiles include next-generation clean energy vehicles such as hybrid vehicles (HEVs), electric vehicles (EVs), and plug-in hybrid vehicles (PHEVs), and the secondary battery can be used as one of the power sources provided for the automobiles. Furthermore, the moving object is not limited to an automobile. Examples of moving vehicles include a train, a monorail train, a ship, and a flying object (a helicopter, an unmanned aircraft (a drone), an airplane, and a rocket), electric vehicles, and electric motorcycles, and the secondary battery of one embodiment of the present invention can be used for the moving vehicles.

The secondary battery of this embodiment may be used in a ground-based charging apparatus provided for a house or a charging station provided in a commerce facility.

FIG. 29A illustrates an example of a mobile phone. A mobile phone 2100 includes a display portion 2102 installed in a housing 2101, an operation button 2103, an external connection port 2104, a speaker 2105, a microphone 2106, and the like. Note that the mobile phone 2100 includes a secondary battery 2107.

The mobile phone 2100 is capable of executing a variety of applications such as mobile phone calls, e-mailing, viewing and editing texts, music reproduction, Internet communication, and computer games.

With the operation button 2103, a variety of functions such as time setting, power on/off operation, wireless communication on/off operation, execution and cancellation of a silent mode, and execution and cancellation of a power saving mode can be performed. For example, the functions of the operation button 2103 can also be set freely by an operating system incorporated in the mobile phone 2100.

In addition, the mobile phone 2100 can execute near field communication conformable to a communication standard. For example, by mutual communication between the mobile phone 2100 and a headset capable of wireless communication, hands-free calling can be performed.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 29B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery of one embodiment of the present invention is preferable as a secondary battery mounted on the unmanned aircraft 2300 because it has a high level of safety and thus can be used safely for a long time over a long period.

Furthermore, as illustrated in FIG. 29C, a secondary battery 2602 including a plurality of secondary batteries 2601 of one embodiment of the present invention may be mounted on a hybrid electric vehicle (HEV), an electric vehicle (EV), a plug-in hybrid electric vehicle (PHEV), or another electronic device.

FIG. 29D illustrates an example of a vehicle including the secondary battery 2602. A vehicle 2603 is an electric vehicle that runs using an electric motor as a power source. Alternatively, the vehicle 2603 is a hybrid electric vehicle that can appropriately select an electric motor or an engine as a driving power source. The vehicle 2603 using the electric motor includes a plurality of ECUs (Electronic Control Units) and performs engine control by the ECUs. The ECU includes a microcomputer. The ECU is connected to a CAN (Controller Area Network) provided in the electric vehicle. The CAN is a type of a serial communication standard used as an in-vehicle LAN. The secondary battery of one embodiment of the present invention can be used to function as a power source of ECU and a vehicle with a high level of safety and a long cruising range can be achieved.

The secondary battery not only drives the electric motor (not illustrated) but also can supply electric power to a light-emitting device such as a headlight or a room light. Furthermore, the secondary battery can supply electric power to a display device and a semiconductor device included in the vehicle 2603, such as a speedometer, a tachometer, and a navigation system.

In the vehicle 2603, the secondary batteries included in the secondary battery 2602 can be charged by being supplied with electric power from external charging equipment by a plug-in system, a contactless power feeding system, or the like.

FIG. 29E illustrates a state in which the vehicle 2603 is supplied with electric power from ground-based charging equipment 2604 through a cable. In charging, a given method such as CHAdeMO (registered trademark) or Combined Charging System may be employed as a charging method, the standard of a connector, or the like as appropriate. For example, with a plug-in technique, the secondary battery 2602 incorporated in the vehicle 2603 can be charged by being supplied with electric power from the outside. Charging can be performed by converting AC power into DC power through a converter such as an ACDC converter. The charging equipment 2604 may be provided for a house as illustrated in FIG. 29E, or may be a charging station provided in a commercial facility.

Although not illustrated, the vehicle can include a power receiving device so as to be charged by being supplied with power from an above-ground power transmitting device in a contactless manner. In the case of the contactless power feeding system, by fitting a power transmitting device in a road or an exterior wall, charging can be performed not only when the vehicle is stopped but also when driven. In addition, this contactless power feeding system may be utilized to transmit and receive power between vehicles. Furthermore, a solar cell may be provided in the exterior of the vehicle to charge the secondary battery when the vehicle stops or moves. To supply power in such a contactless manner, an electromagnetic induction method or a magnetic resonance method can be used.

The house illustrated in FIG. 29E includes a power storage system 2612 including the secondary battery of one embodiment of the present invention and a solar panel 2610. The power storage system 2612 is electrically connected to the solar panel 2610 through a wiring 2611 or the like. The power storage system 2612 may be electrically connected to the ground-based charging equipment 2604. The power storage system 2612 can be charged with electric power generated by the solar panel 2610. The secondary battery 2602 included in the vehicle 2603 can be charged with the electric power stored in the power storage system 2612 through the charging equipment 2604.

The electric power stored in the power storage system 2612 can also be supplied to other electronic devices in the house. Thus, with the use of the power storage system 2612 of one embodiment of the present invention as an uninterruptible power source, electronic devices can be used even when electric power cannot be supplied from a commercial power source due to power failure or the like.

This embodiment can be implemented in appropriate combination with the other embodiments.

### REFERENCE NUMERALS

102: space in heating furnace, 104: hot plate, 106: heater unit, 108: heat insulator, 116: container, 118: lid, 119: space, 120: heating furnace, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 400: secondary battery, 410: positive electrode, 411: positive electrode active material, 413: positive electrode current collector, 414: positive electrode active material layer, 420: solid electrolyte layer, 421: solid electrolyte, 430: negative electrode, 431: negative electrode active material, 433: negative electrode current collector, 434: negative electrode active material layer, 500: secondary battery, 503: positive electrode, 506: negative electrode, 507: separator, 509: exterior body, 510: positive electrode lead electrode, 511: negative electrode lead electrode, 600: secondary battery, 601: positive electrode cap, 602: battery can, 603: positive electrode terminal, 604: positive electrode, 605: separator, 606: negative electrode, 607: negative electrode terminal, 608: insulating plate, 609: insulating plates, 611: PTC element, 612: safety valve mechanism, 613: conductive plate, 614: conductive plate, 615: module, 616: conductive wire, 617: temperature control device, 901: lithium oxide, 902: fluoride, 903: mixture, 904: positive electrode active material, 913: secondary battery, 930: housing, 931: negative electrode, 932: positive electrode, 933: separator, 950: wound body, 951: terminal, 952: terminal, 2100: mobile phone, 2101: housing, 2102: display portion, 2103: operation button, 2104: external connection port, 2105: speaker, 2106: microphone, 2107: secondary battery, 2300: unmanned aircraft, 2301: secondary battery, 2302: rotor, 2303: camera, 2601: secondary battery, 2602: secondary battery, 2603: vehicle, 2604: charging equipment, 2610: solar panel, 2611: wiring, 2612: power storage system

1. A secondary battery comprising a positive electrode, a negative electrode, and an electrolyte solution,
wherein the positive electrode comprises a positive electrode active material,
wherein the positive electrode active material comprises lithium, cobalt, oxygen, magnesium, aluminum, and fluorine,
wherein the positive electrode active material is a crystal represented by a layered rock-salt structure,
wherein a space group of the crystal is represented by R-3m,
wherein a concentration of the fluorine is higher in a surface portion of the crystal than inside the crystal,
wherein a concentration of the magnesium is higher in the surface portion of the crystal than inside the crystal, and
wherein an atomic ratio of the magnesium to the aluminum is higher in the surface portion of the crystal than inside the crystal.

2. A positive electrode active material comprising lithium, cobalt, oxygen, magnesium, aluminum, and fluorine,
wherein the positive electrode active material is a crystal represented by a layered rock-salt structure,
wherein a space group of the crystal is represented by R-3m,
wherein a concentration of the fluorine is higher in a surface portion of the crystal than inside the crystal,
wherein a concentration of the magnesium is higher in the surface portion of the crystal than inside the crystal, and
wherein an atomic ratio of the magnesium to the aluminum is higher in the surface portion of the crystal than inside the crystal.

3. A positive electrode active material comprising lithium, cobalt, oxygen, magnesium, aluminum, and fluorine,
wherein the positive electrode active material is a crystal represented by a layered rock-salt structure,
wherein a space group of the crystal is represented by R-3m,
wherein a concentration of the fluorine is higher in a surface portion of the crystal than inside the crystal,
wherein a concentration of the magnesium is higher in the surface portion of the crystal than inside the crystal,
wherein an atomic ratio of the magnesium to the aluminum is higher in the surface portion of the crystal than inside the crystal,
wherein a region in contact with an outside of a surface of the crystal is included,
wherein the region comprises magnesium, lithium, and fluorine, and
wherein the concentration of the fluorine with respect to the concentration of the magnesium is higher in the region than in the surface portion of the crystal.

4. The positive electrode active material according to claim 2,
further comprising titanium,
wherein an atomic ratio of the magnesium to the titanium is higher in the surface portion of the crystal than inside the crystal.

5. The positive electrode active material according to claim 2,
further comprising nickel and titanium,
wherein an atomic ratio of the magnesium to the nickel is higher in the surface portion of the crystal than inside the crystal, and
wherein an atomic ratio of the magnesium to the titanium is higher in the surface portion of the crystal than inside the crystal.

6. A positive electrode active material comprising lithium, cobalt, oxygen, magnesium, aluminum, and fluorine,
wherein the positive electrode active material is a crystal represented by a layered rock-salt structure,
wherein a space group of the crystal is represented by R-3m,
wherein the crystal comprises a first region and a second region,
wherein the first region is in contact with a surface of the crystal,
wherein the second region is positioned inward from the first region,
wherein a concentration of the fluorine is higher in the first region than in the second region,
wherein a concentration of the magnesium is higher in the first region than in the second region, and
wherein an atomic ratio of the magnesium to the aluminum is higher in the first region than in the second region.

7. A positive electrode active material comprising lithium, cobalt, oxygen, magnesium, aluminum, and fluorine,
wherein the positive electrode active material is a crystal represented by a layered rock-salt structure,
wherein a space group of the crystal is represented by R-3m,
wherein the crystal comprises a first region and a second region,
wherein the first region is in contact with a surface of the crystal,
wherein the second region is positioned inward from the first region,
wherein a concentration of the fluorine is higher in the first region than in the second region,
wherein a concentration of the magnesium is higher in the first region than in the second region,
an atomic ratio of the magnesium to the aluminum is higher in the first region than in the second region,
wherein the crystal comprises a third region,
wherein the third region is in contact with the surface of the crystal,
wherein the third region comprises magnesium, lithium, and fluorine, and
wherein the concentration of the fluorine with respect to the concentration of the magnesium is higher in the third region than in the first region.

8. The positive electrode active material according to claim 6,
further comprising titanium,
wherein an atomic ratio of the magnesium to the titanium is higher in the first region than in the second region.

9. The positive electrode active material according to claim 6,
further comprising titanium and nickel,
wherein an atomic ratio of the magnesium to the titanium is higher in the first region than in the second region, and
wherein an atomic ratio of the magnesium to the nickel is higher in the first region than in the second region.

10. The positive electrode active material according to claim 6,
wherein the first region is a region from the surface of the crystal to a depth of less than or equal to 50 nm.

11. A secondary battery comprising a positive electrode comprising the positive electrode active material according to claim 2, a negative electrode, and an electrolyte.

12. A vehicle comprising the secondary battery according to claim 1, an electric motor, and a control device,
wherein the control device is configured to supply power from the secondary battery to the electric motor.

13. A vehicle comprising the secondary battery according to claim 11, an electric motor, and a control device,
wherein the control device is configured to supply power from the secondary battery to the electric motor.

14. The positive electrode active material according to claim 3,
further comprising titanium,
wherein an atomic ratio of the magnesium to the titanium is higher in the surface portion of the crystal than inside the crystal.

15. The positive electrode active material according to claim 3,
further comprising nickel and titanium,
wherein an atomic ratio of the magnesium to the nickel is higher in the surface portion of the crystal than inside the crystal, and
wherein an atomic ratio of the magnesium to the titanium is higher in the surface portion of the crystal than inside the crystal.

16. A secondary battery comprising a positive electrode comprising the positive electrode active material according to claim 3, a negative electrode, and an electrolyte.

17. A vehicle comprising the secondary battery according to claim 16, an electric motor, and a control device,
wherein the control device is configured to supply power from the secondary battery to the electric motor.

18. A secondary battery comprising a positive electrode comprising the positive electrode active material according to claim 6, a negative electrode, and an electrolyte.

19. A vehicle comprising the secondary battery according to claim 18, an electric motor, and a control device,
wherein the control device is configured to supply power from the secondary battery to the electric motor.

20. The positive electrode active material according to claim 7,
further comprising titanium,
wherein an atomic ratio of the magnesium to the titanium is higher in the first region than in the second region.

21. The positive electrode active material according to claim 7,
further comprising titanium and nickel,
wherein an atomic ratio of the magnesium to the titanium is higher in the first region than in the second region, and
wherein an atomic ratio of the magnesium to the nickel is higher in the first region than in the second region.

22. The positive electrode active material according to claim 7,
wherein the first region is a region from the surface of the crystal to a depth of less than or equal to 50 nm.

23. A secondary battery comprising a positive electrode comprising the positive electrode active material according to claim 7, a negative electrode, and an electrolyte.

24. A vehicle comprising the secondary battery according to claim 23, an electric motor, and a control device,
wherein the control device is configured to supply power from the secondary battery to the electric motor.
